(19) United States
(12) Patent Application Publication
(10) Pub. No.: US 2026/0075314 A1
(43) Pub. Date: Mar. 12, 2026

(54) IMAGE SENSOR AND IMAGE CAPTURING APPARATUS

(71) Applicant: CANON KABUSHIKI KAISHA, Tokyo (JP)

(72) Inventors: SHUNICHI WAKASHIMA, Tokyo (JP); KOICHI FUKUDA, Tokyo (JP); KOHEI OKAMOTO, Kanagawa (JP); TETSU OIKAWA, Kanagawa (JP)

(21) Appl. No.: 19/311,450

(22) Filed: Aug. 27, 2025

(30) Foreign Application Priority Data
Sep. 6, 2024 (JP) 2024-154235

(51) Int. Cl. H04N 23/67; H04N 25/13; H04N 25/65; H04N 25/771; H04N 25/772

(52) U.S. Cl. CPC H04N 23/672; H04N 25/134; H04N 25/771; H04N 25/772; H04N 25/65

(57) ABSTRACT

An image sensor comprises: a pixel array in which a plurality of pixels are arranged; and a first memory configured to hold signals outputted from the pixel array. Each of the plurality of pixels includes: a plurality of photoelectric conversion units configured to photoelectrically convert light that has passed through different pupil regions of an imaging optical system, and respectively output analog signals; an analog-to-digital conversion unit that converts the analog signals outputted from the plurality of photoelectric conversion units into digital signals; and a latch unit that latches the digital signals converted by the analog-to-digital conversion unit. The first memory holds the digital signals latched by the latch unit.

### BACKGROUND

### Field of the Technology

The present invention relates to an image sensor in which pixel units each having a plurality of photoelectric conversion units are two-dimensionally arranged, and an image capturing apparatus equipped with the image sensor.

### Description of the Related Art

As one of focus detection methods performed in an image capturing apparatus, a so-called on-imaging plane phase difference method in which a pair of pupil division signals are obtained using focus detection pixels formed in an image sensor and phase difference focus detection is performed using the pair of pupil division signals is known. As an example of such on-imaging plane phase difference focus detection (hereinafter referred to as “on-imaging plane phase difference AF”), an image capturing apparatus using an image sensor in which pixels, each formed with one microlens (ML) and a plurality of photoelectric conversion units, are two-dimensionally arranged is disclosed in Japanese Patent Laid-Open No. S58-24105.

Each of the plurality of photoelectric conversion units is configured to receive light transmitted through a different region of the exit pupil of an imaging lens via one ML to realize pupil division. Then, by calculating the image shift amount using the phase difference signals, which are the signals of the respective photoelectric conversion units, on-imaging plane phase difference AF can be performed. Further, an image can be acquired from an image signal obtained by adding the signals from the individual photoelectric conversion units for each pixel.

In such an image sensor, in a configuration in which a plurality of photoelectric conversion units are arranged in the horizontal direction within a pixel and thus pupil division is in the horizontal direction, in a case where a subject has horizontal stripes or the like that make horizontal parallax less likely to appear, focus detection accuracy may decrease. Japanese Patent Laid-Open No. 2011-53519 discloses a technique for improving focus detection accuracy by arranging the photoelectric conversion units of the focus detection pixels in two directions to make the pupil division directions to two.

Further, among electronic shutter methods in image sensors, a global electronic shutter (GS) method allows exposure to be performed simultaneously in all the pixels and allows images to be captured without moving object distortion, which occurs in a rolling shutter method in which exposure is performed sequentially by row. Japanese Patent Laid-Open No. 2019-134230 discloses a configuration that realizes a global shutter by arranging a light receiving portion and an Analog-to-Digital Converter (ADC) in a pixel and performing AD conversion simultaneously for all pixels. Further, in this method, since signals read from the pixels are digital signals, high-speed signal readout is possible, as compared with an image sensor in which analog signals are read out from the pixels.

Japanese Patent Laid-Open No. 2019-134230 discloses a configuration in which phase difference detection pixels are included in an image sensor that has a high simultaneity due to an all-pixel simultaneous exposure function and a high-speed readout capability due to digital signal readout, but does not disclose an appropriate arrangement of vertically divided pixels and horizontally divided pixels. Therefore, in vertical phase difference detection and horizontal phase difference detection, there may be significant unevenness in detection performance and differences in the area in which focus detection is possible.

### SUMMARY

The present disclosure has been made in consideration of the above situation, and achieves both high-speed readout and acquisition of highly simultaneous signals from an image sensor.

According to the present disclosure, provided is an image sensor comprising: a pixel array in which a plurality of pixels are arranged; and a first memory configured to hold signals outputted from the pixel array, each of the plurality of pixels including: a plurality of photoelectric conversion units that photoelectrically convert light that has passed through different pupil regions of an imaging optical system, and respectively output analog signals; an analog-to-digital conversion unit that converts the analog signals outputted from the plurality of photoelectric conversion unit into digital signals; and a latch unit that latches the digital signals converted by the analog-to-digital conversion unit, wherein the first memory holds the digital signals latched by the latch unit.

Further, according to the present disclosure, provided is an image capturing apparatus comprising: an image sensor that comprises: a pixel array in which a plurality of pixels are arranged; and a first memory configured to hold signals outputted from the pixel array, each of the plurality of pixels including: a plurality of photoelectric conversion units that photoelectrically convert light that has passed through different pupil regions of an imaging optical system, and respectively output analog signals; an analog-to-digital conversion unit that converts the analog signals outputted from the plurality of photoelectric conversion unit into digital signals; and a latch unit that latches the digital signals converted by the analog-to-digital conversion unit; an actuation unit that actuates the plurality of pixels; a second memory that holds digital signals latched by latch unit; and a subtraction unit; and a focus detection unit that performs phase difference focus detection by using the pair of focus detection signals having parallax, obtained from the first signal and the second signal, wherein the first memory holds the digital signals latched by the latch unit, the actuation unit actuates the plurality of pixels so as to simultaneously output the analog signals to the analog-to-digital conversion unit, a noise signal, which has been obtained by the analog-to-digital conversion unit converting an analog signal when each of the plurality of pixels is reset into a digital signal and has been latched by the latch unit, is held in the first memory, a first signal obtained by the subtraction unit subtracting, from a signal, which has been obtained by the analog-to-digital conversion unit converting an analog signal outputted from part of the plurality of photoelectric conversion units of each of the plurality of pixels into a digital signal and has been latched by the latch unit, the noise signal, which is held in the first memory and corresponds to the same pixel, is held in the second memory, and a second signal obtained by the subtraction unit subtracting, from a signal, which has been obtained by the analog-to-digital conversion unit converting an analog signal outputted from the plurality of photoelectric conversion units of each of the plurality of pixels and has been latched by the latch unit, the noise signal, which is held in the first memory and corresponds to the same pixel, is held in the first memory, and the subtraction unit is implemented by one or more processors, circuitry or a combination thereof.

Furthermore, according to the present disclosure, provided is an image capturing apparatus comprising: an image sensor that comprises: a pixel array in which a plurality of pixels are arranged; and a first memory configured to hold signals outputted from the pixel array, each of the plurality of pixels including: a plurality of photoelectric conversion units that photoelectrically convert light that has passed through different pupil regions of an imaging optical system, and respectively output analog signals; an analog-to-digital conversion unit that converts the analog signals outputted from the plurality of photoelectric conversion unit into digital signals; and a latch unit that latches the digital signals converted by the analog-to-digital conversion unit; an actuation unit that actuates the plurality of pixels; an addition unit that adds digital signals, which have been latched by latch unit, in units corresponding to a predetermined number of pixels; a second memory and a third memory configured to hold added signals obtained by addition by the addition unit; and a subtraction unit; and a focus detection unit that performs phase difference focus detection by using the pair of focus detection signals having parallax, obtained from the first signal and the second signal, wherein the first memory holds the digital signals latched by the latch unit, the actuation unit actuates the plurality of pixels so as to simultaneously output the analog signals to the analog-to-digital conversion unit, noise signals, each obtained by the analog-to-digital conversion unit converting an analog signal when each of the plurality of pixels is reset into a digital signal and latched by the latch unit, are added by the addition unit, and an added noise signal is held in the second memory, a first signal obtained by the subtraction unit subtracting, from a signal obtained by the addition unit adding signals, each obtained by the analog-to-digital conversion unit converting an analog signal outputted from part of the plurality of photoelectric conversion units of each of the plurality of pixels into a digital signal and latched by the latch unit, the added noise signal, which is held in the second memory and corresponds to the same pixel, is held in the third memory, a second signal obtained by the subtraction unit subtracting, from a signal obtained by the addition unit adding signals, each obtained by the analog-to-digital conversion unit converting an analog signal outputted from the plurality of photoelectric conversion units of each of the plurality of pixels into a digital signal and latched by the latch unit, the added noise signal, which is held in the second memory and corresponds to the same pixel, is held in the second memory, and the addition unit and the subtraction unit are implemented by one or more processors, circuitry or a combination thereof.

Further, according to the present disclosure, provided is an image capturing apparatus comprising: an image sensor that comprises: a pixel array in which a plurality of pixels are arranged; and a first memory configured to hold signals outputted from the pixel array, each of the plurality of pixels including: a plurality of photoelectric conversion units that photoelectrically convert light that has passed through different pupil regions of an imaging optical system, and respectively output analog signals; an analog-to-digital conversion unit that converts the analog signals outputted from the plurality of photoelectric conversion unit into digital signals; and a latch unit that latches the digital signals converted by the analog-to-digital conversion unit; an actuation unit that actuates the plurality of pixels; a second memory and a third memory configured to hold digital signals thinned out at a predetermined interval among digital signals corresponding to the plurality of pixels; and a subtraction unit; and a focus detection unit that performs phase difference focus detection by using the pair of focus detection signals having parallax, obtained from the first signal and the second signal, wherein the first memory holds the digital signals latched by the latch unit, the actuation unit actuates the plurality of pixels so as to simultaneously output the analog signals to the analog-to-digital conversion unit, a thinned noise signal, which has been obtained by thinning out noise signals, each obtained by the analog-to-digital conversion unit converting an analog signal when each of the plurality of pixels is reset into a digital signal and latched by the latch unit, is held in the second memory, a first signal obtained by the subtraction unit subtracting, from a signal obtained by thinning out signals, each obtained by the analog-to-digital conversion unit converting an analog signal outputted from part of the plurality of photoelectric conversion units of each of the plurality of pixels into a digital signal and latched by the latch unit, the thinned noise signal, which is held in the second memory and corresponds to the same pixel, is held in the third memory, a second signal obtained by the subtraction unit subtracting, from a signal obtained by thinning signals, each obtained by the analog-to-digital conversion unit converting an analog signal outputted from the plurality of photoelectric conversion units of each of the plurality of pixels into a digital signal and latched by the latch unit, the thinned noise signal, which is held in the second memory and corresponds to the same pixel, is held in the second memory, and the subtraction unit is implemented by one or more processors, circuitry or a combination thereof.

Further, according to the present disclosure, provided is an image capturing apparatus comprising: an image sensor that comprises: a pixel array in which a plurality of pixels are arranged; and a first memory configured to hold signals outputted from the pixel array, each of the plurality of pixels including: a plurality of photoelectric conversion units that photoelectrically convert light that has passed through different pupil regions of an imaging optical system, and respectively output analog signals; an analog-to-digital conversion unit that converts the analog signals outputted from the plurality of photoelectric conversion unit into digital signals; and a latch unit that latches the digital signals converted by the analog-to-digital conversion unit; an actuation unit that actuates the plurality of pixels; a second memory, a third memory, and a fourth memory configured to hold digital signals latched by latch unit; and a subtraction unit; a dynamic range expansion unit that obtains a pair of focus detection signals having parallax and expanded dynamic range, using the first to fourth signals; and a focus detection unit that performs phase difference focus detection by using the pair of focus detection signals having parallax and expanded dynamic range, wherein the first memory holds the digital signals latched by the latch unit, the actuation unit actuates the plurality of pixels so as to simultaneously output the analog signals to the analog-to-digital conversion unit, a noise signal, which has been obtained by the analog-to-digital conversion unit converting an analog signal when each of the plurality of pixels is reset into a digital signal and has been latched by the latch unit, is held in the first memory, a first signal obtained by the subtraction unit subtracting, from a signal, which has been obtained by the analog-to-digital conversion unit converting an analog signal outputted from part of the plurality of photoelectric conversion units of each of the plurality of pixels after the plurality of photoelectric conversion units have been exposed for a predetermined first exposure period into a digital signal and has been latched by the latch unit, the noise signal, which is held in the first memory and corresponds to the same pixel, is held in the second memory, a second signal obtained by the subtraction unit subtracting, from a signal, which has been obtained by the analog-to-digital conversion unit converting an analog signal outputted from the plurality of photoelectric conversion units of each of the plurality of pixels after the first signal is held in the second memory into a digital signal and has been latched by the latch unit, the noise signal, which is held in the first memory and corresponds to the same pixel, is held in the first memory, a noise signal, which has been obtained by the analog-to-digital conversion unit converting an analog signal when each of the plurality of pixels is reset after the second signal is held in the first memory into a digital signal and has been latched by the latch unit, is held in the third memory, a third signal obtained by the subtraction unit subtracting, from a signal, which has been obtained by the analog-to-digital conversion unit converting an analog signal outputted from part of the plurality of photoelectric conversion units of each of the plurality of pixels after the plurality of photoelectric conversion units have been exposed for a predetermined second exposure period, which is different from the first exposure period, into a digital signal and has been latched by the latch unit, the noise signal, which is held in the third memory and corresponds to the same pixel, is held in the fourth memory, a fourth signal obtained by the subtraction unit subtracting, from a signal, which has been obtained by the analog-to-digital conversion unit converting an analog signal outputted from the plurality of photoelectric conversion units of each of the plurality of pixels after the third signal is held in the fourth memory into a digital signal and has been latched by the latch unit, the noise signal, which is held in the third memory and corresponds to the same pixel, is held in the third memory, and the subtraction unit is implemented by one or more processors, circuitry or a combination thereof.

Further, according to the present disclosure, provided is an image capturing apparatus comprising: an image sensor that comprises: a pixel array in which a plurality of pixels are arranged; and a first memory configured to hold signals outputted from the pixel array, each of the plurality of pixels including: a plurality of photoelectric conversion units that photoelectrically convert light that has passed through different pupil regions of an imaging optical system, and respectively output analog signals; an analog-to-digital conversion unit that converts the analog signals outputted from the plurality of photoelectric conversion unit into digital signals; and a latch unit that latches the digital signals converted by the analog-to-digital conversion unit; an actuation unit that actuates the plurality of pixels; an addition unit that adds digital signals, which have been latched by latch unit, in units corresponding to a predetermined number of pixels; a second memory and a third memory configured to hold added signals obtained by addition by the addition unit; and a subtraction unit; and a display unit that displays an image based on the second signal, wherein the first memory holds the digital signals latched by the latch unit, the actuation unit actuates the plurality of pixels so as to simultaneously output the analog signals to the analog-to-digital conversion unit, noise signals, each obtained by the analog-to-digital conversion unit converting an analog signal when each of the plurality of pixels is reset into a digital signal and latched by the latch unit, are added by the addition unit, and an added noise signal is held in the second memory, a first signal obtained by the subtraction unit subtracting, from a signal obtained by the addition unit adding signals, each obtained by the analog-to-digital conversion unit converting an analog signal outputted from part of the plurality of photoelectric conversion units of each of the plurality of pixels into a digital signal and latched by the latch unit, the added noise signal, which is held in the second memory and corresponds to the same pixel, is held in the third memory, a second signal obtained by the subtraction unit subtracting, from a signal obtained by the addition unit adding signals, each obtained by the analog-to-digital conversion unit converting an analog signal outputted from the plurality of photoelectric conversion units of each of the plurality of pixels into a digital signal and latched by the latch unit, the added noise signal, which is held in the second memory and corresponds to the same pixel, is held in the second memory, and the addition unit and the subtraction unit are implemented by one or more processors, circuitry or a combination thereof.

Further, according to the present disclosure, provided is an image capturing apparatus comprising: an image sensor hat comprises: a pixel array in which a plurality of pixels are arranged; and a first memory configured to hold signals outputted from the pixel array, each of the plurality of pixels including: a plurality of photoelectric conversion units that photoelectrically convert light that has passed through different pupil regions of an imaging optical system, and respectively output analog signals; an analog-to-digital conversion unit that converts the analog signals outputted from the plurality of photoelectric conversion unit into digital signals; and a latch unit that latches the digital signals converted by the analog-to-digital conversion unit; an actuation unit that actuates the plurality of pixels; a second memory and a third memory configured to hold digital signals thinned out at a predetermined interval among digital signals corresponding to the plurality of pixels; and a subtraction unit; and a display unit that displays an image based on the second signal, wherein the first memory holds the digital signals latched by the latch unit, the actuation unit actuates the plurality of pixels so as to simultaneously output the analog signals to the analog-to-digital conversion unit, a thinned noise signal, which has been obtained by thinning out noise signals, each obtained by the analog-to-digital conversion unit converting an analog signal when each of the plurality of pixels is reset into a digital signal and latched by the latch unit, is held in the second memory, a first signal obtained by the subtraction unit subtracting, from a signal obtained by thinning out signals, each obtained by the analog-to-digital conversion unit converting an analog signal outputted from part of the plurality of photoelectric conversion units of each of the plurality of pixels into a digital signal and latched by the latch unit, the thinned noise signal, which is held in the second memory and corresponds to the same pixel, is held in the third memory, a second signal obtained by the subtraction unit subtracting, from a signal obtained by thinning signals, each obtained by the analog-to-digital conversion unit converting an analog signal outputted from the plurality of photoelectric conversion units of each of the plurality of pixels into a digital signal and latched by the latch unit, the thinned noise signal, which is held in the second memory and corresponds to the same pixel, is held in the second memory, and the subtraction unit is implemented by one or more processors, circuitry or a combination thereof.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram schematically showing an overall configuration of an image sensor according to a first embodiment.

FIG. 2 is a diagram schematically showing a circuit configuration of a pixel according to the first embodiment.

FIG. 3 is a timing diagram schematically showing operation timings according to the first embodiment.

FIG. 4 is a diagram showing a basic layout of elements constituting a pixel portion on a PD substrate side according to the first embodiment.

FIGS. 5A to 5C are diagrams schematically showing a basic cross-sectional structure of partial pixels on the PD substrate side according to the first embodiment.

FIGS. 6A to 6D are diagrams schematically showing an xy cross-section of PDA and PDB according to the first embodiment for each depth.

FIG. 7 is a diagram schematically showing a D-D′ cross-section of FIG. 4 according to the first embodiment.

FIGS. 8A to 8C are diagrams schematically showing a horizontally divided pixel according to the first embodiment.

FIGS. 9A to 9C are diagrams schematically showing a vertically divided pixel according to the first embodiment.

FIG. 10 is a diagram schematically showing an arrangement of horizontally divided pixels and vertically divided pixels and an arrangement of color filters in a range of 2×2 pixels according to the first embodiment.

FIG. 11 is a block diagram showing a schematic configuration of an image capturing apparatus according to the first embodiment.

FIG. 12 is a diagram for explaining a correspondence between a pixel of the image sensor and a pupil intensity distribution according to the first embodiment.

FIG. 13 is a diagram schematically showing the pupil intensity distribution according to the first embodiment.

FIG. 14 is a diagram for explaining a correspondence between the image sensor and the pupil intensity distribution according to the first embodiment.

FIG. 15 is a diagram for explaining pupil division in an imaging optical system and the image sensor according to the first embodiment.

FIG. 16 is a diagram schematically showing an overall configuration of an image sensor according to a second embodiment.

FIGS. 17A to 17D are diagrams schematically showing a live view signal readout operation according to the second embodiment.

FIGS. 18A to 18C are diagrams schematically showing an image signal readout operation according to the second embodiment.

FIG. 19 is a diagram schematically showing an overall configuration of an image sensor according to a third embodiment.

FIGS. 20A to 20D are diagrams schematically showing an image capturing operation/live view operation according to the third embodiment.

FIG. 21 is a diagram schematically showing an arrangement of color filters in a range of 2×2 pixels according to a modification.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### [Configuration of Image Sensor]

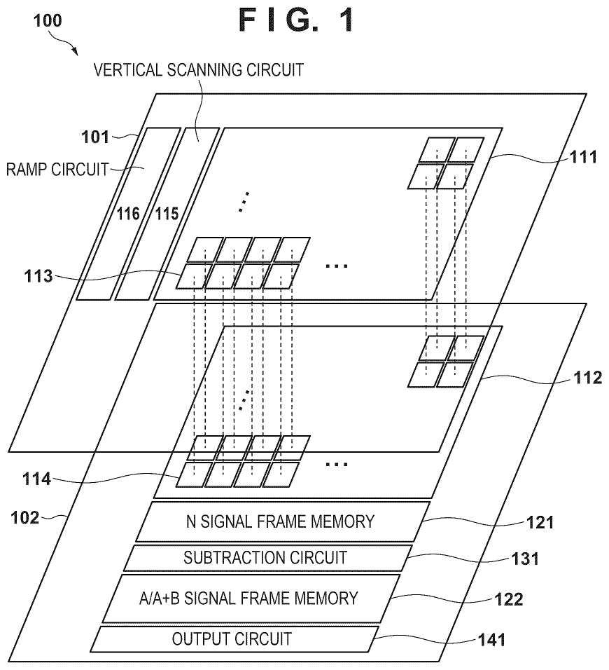

FIG. 1 is a diagram schematically showing the overall configuration of an image sensor 100 according to a first embodiment of the present invention.

The image sensor 100 is constituted by stacking a substrate 101 (referred to as “PD substrate”, hereinafter) disposed on the light incident side and a substrate 102 (referred to as “TAD substrate”, hereinafter) disposed on the opposite side of the light incident side. A PD substrate-side portion 111 of a pixel array, a vertical scanning circuit 115, and a ramp circuit 116 are disposed on the PD substrate 101, and a TAD substrate-side portion 112 of the pixel array is disposed on the TAD substrate 102. A plurality of pixels are arranged in a matrix in the pixel array, and each pixel is constituted by a pixel portion 113 configured on the PD substrate 101, and a pixel portion 114 configured on the TAD substrate 102. In FIG. 1, the vertical scanning circuit 115 and the ramp circuit 116 are disposed to the left of the PD substrate-side portion 111 of the pixel array, but are not limited to this, and may be arranged in an empty region, excluding the PD substrate-side portion 111 of the PD substrate 101.

In addition, an N signal frame memory 121, a subtraction circuit 131, an A/A+B signal frame memory 122, and an output circuit 141 are further disposed on the TAD substrate 102. The number of bits of each memory of the N signal frame memory 121 is smaller than the number of bits of each memory of the A/A+B signal frame memory 122. However, the number of bits of each memory of the N signal frame memory 121 and the number of bits of each memory of the A/A+B signal frame memory 122 may be made the same. Further, each of the N signal frame memory 121 and the A/A+B signal frame memory 122 has memories corresponding to the number of pixels of the pixel array.

### [Pixel Circuit]

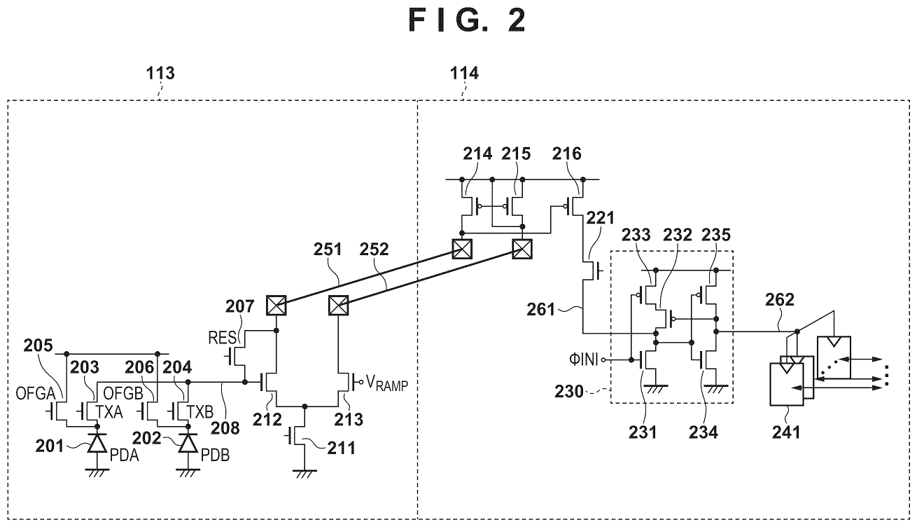

FIG. 2 is a diagram schematically showing a circuit configuration of one pixel according to the present embodiment, and the pixel portion 113 constituted on the PD substrate 101, the pixel portion 114 constituted on the TAD substrate 102 are shown side by side.

The pixel portion 113 is constituted by a PDA 201 and a PDB 202 which are photoelectric conversion units, a charge-voltage converter (FD) 208 for converting a signal charge to a voltage, a transfer transistor (TXA) 203 for transferring a signal charge accumulated in the PDA 201 to the FD 208, a transfer transistor (TXB) 204 for transferring a signal charge accumulated in the PDB 202 to the FD 208, an overflow gate (OFGA) 205 for resetting the PDA by discharging its charge, an overflow gate (OFGB) 206 for resetting the PDB by discharging its charge, a reset transistor (RES) 207 for resetting the FD 208 by discharging its signal charge, a current source transistor 211 of a differential amplifier, a differential amplifier input transistor 212 on the FD 208 side, and a differential amplifier input transistor 213 on the ramp signal side (to be described later).

The on/off of the TXA 203, the TXB 204, the OFGA 205, the OFGB 206, the RES 207 is controlled by the vertical scanning circuit 115, and the gate of the differential amplifier input transistor 213 is supplied with a ramp signal V_{RAMP} from the ramp circuit 116.

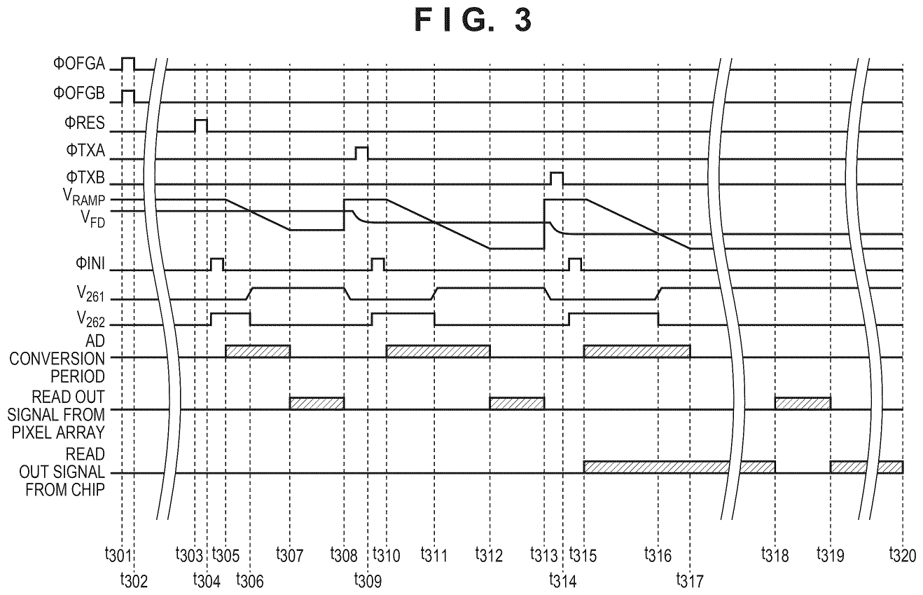

The pixel portion 114 is constituted by a transistor 214 and a transistor 215 which are active loads of the differential amplifier, a source-grounded transistor 216, a voltage limiting transistor 221, a positive feedback circuit 230, and latch circuits 241 corresponding to the number of bits. The positive feedback circuit 230 is constituted by a transistor 231, a transistor 232, a transistor 233, a transistor 234, and a transistor 235. The latch circuit 241 latches a count signal corresponding to the time when the positive feedback circuit 230 inverted. The count signal latched by the latch circuit 241 is a digital signal corresponding to a voltage (analog signal) corresponding to the charge inputted from the pixel portion 113, and with this, analog-to-digital (AD) conversion is performed. This operation will be described later with reference to FIG. 3.

The TXA 203, the TXB 204, the OFGA 205, the OFGB 206, the RES 207, the transistor 211, the transistor 212, the transistor 213, the transistor 221, the transistor 231, and the transistor 234 are NMOS transistors, and the transistor 214, the transistor 215, the transistor 216, the transistor 232, the transistor 233, and the transistor 235 are PMOS transistors. Further, these connections between the transistors are as shown in FIG. 2.

A wire 251 connecting the drain of the transistor 212 and the drain of the transistor 214, and a wire 252 connecting the drain of the transistor 213 and the drain of the transistor 215 span the PD substrate 101 and the TAD substrate 102, and include inter-substrate connections such as hybrid bonding. The PDA 201 and the PDB 202 to the transistor 221 are constituted by relatively high voltage transistors, and the transistor 231, the transistor 232, the transistor 233, the transistor 234, the transistor 235, and transistors constituting the latch circuits 241 are constituted by relatively low voltage transistors. Further, the power supply voltage supplied to the low voltage transistors is lower than the power supply voltage supplied to the high voltage transistors. A low power supply voltage can keep power consumption low, and low voltage transistors allow use of fine transistors, making it possible to reduce the pixel pitch.

### [Operation Timings]

FIG. 3 is an operation timing diagram of the present embodiment. The operation of the present embodiment will be described with reference to FIG. 3. In this specification, each timing is shown as “t₃₀₁”. In addition, φOFGA indicates on/off of the OFGA 205, with the upper side indicating on and the lower side indicating off. It is similar for other switches. V_{FD} indicates an example of how the voltage of the FD 208 changes, and it is similar for other nodes. In the present embodiment, resetting of the photoelectric conversion units, N signal conversion, N+A signal conversion, and N+A+B signal conversion, which will be described later, are performed simultaneously for all the pixels. Therefore, a global shutter operation in which the accumulation time is the same in all pixels is achieved.

Resetting Photoelectric Conversion Units Before starting the accumulation operation, the OFGA 205 and the OFGB 206 are turned on (t₃₀₁) and off (t₃₀₂) to discharge charges in the PDA 201 and the PDB 202, and then accumulation is started.

### AD Conversion of N Signal

After that, the RES 207 is turned on (t₃₀₃) and off (t₃₀₄) to reset the voltage of the FD 208 to a high voltage, and φINI is turned on and off to initialize the positive feedback circuit 230. When initialized, the positive feedback circuit 230 sets a positive feedback circuit output V₂₆₂ to a high voltage.

After that, the voltage of the ramp signal V_{RAMP}, which is inputted to the differential amplifier input transistor 213 on the ramp signal side, is dropped over time to input a count signal to the latch circuit 241. During the ramp signal input period (t₃₀₅ to t₃₀₇), when the V_{RAMP} falls below V_{FD}, the differential amplifier output inverts from a high voltage to a low voltage. In response to inversion of the differential amplifier output, the output of the source-grounded transistor 216 inverts from a low voltage to a high voltage, but regarding the inversion rate at this time, the inversion rate of the output V₂₆₁ of the source-grounded transistor 216 is faster than the inversion rate of the differential amplifier output. A low voltage portion of the inversion of the output V₂₆₁ of the source-grounded transistor 216 is inputted to the positive feedback circuit 230 via the voltage limiting transistor 221, but a portion at or above a given voltage is blocked by the voltage limiting transistor 221 and is not inputted to the positive feedback circuit 230.

In response to an increase in the output voltage of the source-grounded transistor 216, the positive feedback circuit 230 inverts the output V₂₆₂ of the positive feedback circuit 230 from a high voltage to a low voltage. In the positive feedback circuit 230, the transistor 234 and the transistor 235 form an inverter (INV) and invert due to an increase in the output V₂₆₁ of the source-grounded transistor 216, but since the output V₂₆₂ of the positive feedback circuit 230, which is also the output of the INV constituted by the transistor 234 and the transistor 235, is also inputted to the transistor 232, the transistor 232 turns on with a decrease in the output V₂₆₂ of the positive feedback circuit 230 and causes the output V₂₆₁ of the source-grounded transistor 216 to increase. With the above positive feedback, the inversion time of the output V₂₆₂ of the positive feedback circuit 230 is faster than the inversion time of the output V₂₆₁ of the source-grounded transistor 216. In response to the inversion of the output V₂₆₂ of the positive feedback circuit 230, the latch circuit 241 holds the count signal at that time. Further, regarding the positive feedback circuit 230, the transistor 231 is off and the transistor 233 is on while φINI is at a low voltage. Therefore, after the output V₂₆₂ of the positive feedback circuit 230 becomes a low voltage while φINI is at a low voltage, the transistor 232 turns on in response to the output V₂₆₂ of the positive feedback circuit 230, and so the output V₂₆₂ of the positive feedback circuit 230 is held at a low voltage until the next time φINI is turned on.

In this way, a count signal (referred to as “N signal” in this specification), which is a noise signal corresponding to V_{FD} after reset, is obtained.

Further, the time (t₃₀₅ to t₃₀₇) from when the ramp signal V_{RAMP} starts to decrease until the decrease is completed is referred to as an N signal AD conversion time.

After AD conversion of the N signal, the N signals, each held in the latch circuit 241 of a respective pixel in the pixel array, are sequentially read out (t₃₀₇ to t₃₀₈) to the N signal frame memory 121 by using a digital readout circuit (not shown), and held.

### AD Conversion of N+A Signal

Subsequently, the TXA 203 is turned on and off (t₃₀₉), and the charges accumulated in the PDA 201 are transferred to the FD 208. The voltage V_{FD} across the FD 208 drops by an amount corresponding to the amount of charge accumulated in the PDA 201.

After φINI is turned on and off, the voltage of the ramp signal V_{RAMP} is dropped over time to input a count signal to the latch circuit 241 (t₃₁₀ to t₃₁₂) as in AD conversion of the N signal. The count signal corresponding to the time when V_{RAMP} falls below V_{FD} (t₃₁₁) is held in the latch circuit 241 as in AD conversion of the N signal. The signal obtained in this way is referred to as an “N+A signal”. Further, the time (t₃₁₀ to t₃₁₂) from when the ramp signal V_{RAMP} starts to decrease until the decrease is completed is referred to as an N+A signal AD conversion time.

After AD conversion of the N+A signal, the N+A signals, each held in the latch circuit 241 of a respective pixel in the pixel array, are sequentially read out (t₃₁₂ to t₃₁₃) to the subtraction circuit 131 by using a digital readout circuit (not shown). At the same time, the N signals of corresponding pixels are sequentially read out from the N signal frame memory 121 to the subtraction circuit 131. The subtraction circuit 131 calculates a difference (hereinafter, referred to as “A signal”) between the inputted N signal and N+A signal, sequentially outputs the A signal to the A/A+B signal frame memory 122, and holds the A signal in the A/A+B signal frame memory 122.

### AD Conversion of N+A+B Signal

Subsequently, the TXB 204 is turned on and off (t₃₁₄), and the charges accumulated in the PDB 202 are transferred to the FD 208. The voltage V_{FD} across the FD 208 drops by an amount corresponding to the amount of charge accumulated in the PDB 202.

After φINI is turned on and off, the voltage of the ramp signal V_{RAMP} is dropped over time to input a count signal to the latch circuit 241 (t₃₁₅ to t₃₁₇) as in AD conversion of the N signal and AD conversion of the N+A signal. The count signal corresponding to the time when V_{RAMP} falls below V_{FD} (t₃₁₆) is held in the latch circuit 241 as in AD conversion of the N signal and AD conversion of the N+A signal. The signal obtained in this way is referred to as an “N+A+B signal”. Further, the time (t₃₁₅ to t₃₁₇) from when the ramp signal V_{RAMP} starts to decrease until the decrease is completed is referred to as an N+A+B signal AD conversion time.

Further, at the same time as AD conversion of the N+A+B signal, the A signal held in the A/A+B signal frame memory 122 is outputted from the chip (t₃₁₅ to t₃₁₈) via the output circuit 141. In the present embodiment, signal readout from the chip is started (t₃₁₅) at the same time as the start of AD conversion of the N+A+B signal but may be started, for example, at t₃₁₃, as long as signal readout from the pixel array for the N+A signal is completed.

After completion of output of the A signal from the chip (t₃₁₈), the N+A+B signals, each held in the latch circuit 241 of a respective pixel in the pixel array, are sequentially read out (t₃₁₈ to t₃₁₉) to the subtraction circuit 131 by using a digital readout circuit (not shown). At the same time, the N signals of corresponding pixels are sequentially read out from the N signal frame memory 121 to the subtraction circuit 131. The subtraction circuit 131 calculates a difference (hereinafter, referred to as “A+B signal”) between the inputted N signal and N+A+B signal, sequentially outputs the A+B signal to the A/A+B signal frame memory 122, and holds the A+B signal in the A/A+B signal frame memory 122.

After completion of readout of the N+A+B signal in the pixel array (t₃₁₉), the A+B signals held in the A/A+B signal frame memory 122 are outputted from the chip via the output circuit 141 (t₃₁₉ to t₃₂₀).

### [Structure of Light Receiving Portion]

### Basic Structure of Light Receiving Portion

Next, the basic configuration of the pixel portion 113 on the PD substrate 101 side in the present embodiment will be described with reference to FIGS. 4 to 7.

FIG. 4 is a schematic diagram showing a basic layout of elements constituting the pixel portion 113 on the PD substrate 101 side according to the present embodiment. In FIG. 4, the horizontal direction of the drawing is the x direction, the downward direction of the drawing is the y direction, and the direction receding into the drawing is the z direction. Further, in the present embodiment, “plan view” refers to a view seen from the z direction or −z direction with respect to a plane (x-y plane) substantially parallel to the surface of the semiconductor substrate on which the gates of the transistors are arranged. Also, in this embodiment, the “horizontal” direction refers to the x direction, the “vertical” direction refers to the y direction, and the “depth”direction refers to the z direction.

In FIG. 4, the same reference numerals are assigned to the same configurations as in FIG. 2, and detailed description thereof will be omitted. In FIG. 4, reference numeral 421 indicates a microlens (ML); 403, the gate electrode of the TXA 203; 404, the gate electrode of the TXB 204; 405, the gate electrode of the OFGA 205; 406, the gate electrode of the OFGB 206; 407, the gate electrode of the RES 207; 411, the gate electrode of the transistor 211; 412, the gate electrode of the transistor 212; and 413, the gate electrode of the transistor 213.

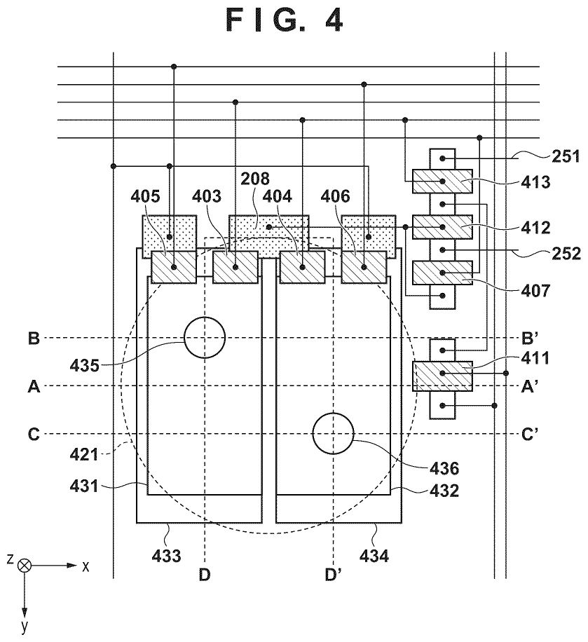

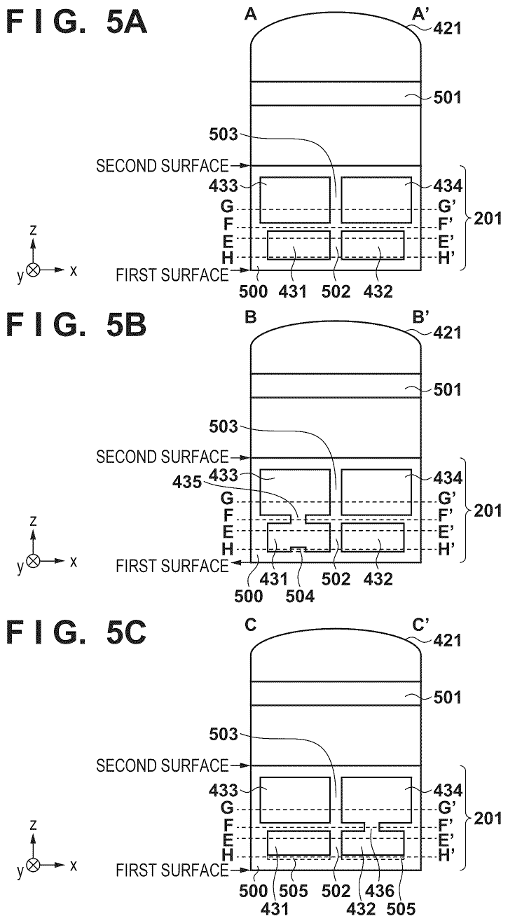

The PDA 201 includes a storage region 431, a sensitivity region 433, and an N-type connection region 435, and the PDB 202 includes a storage region 432, a sensitivity region 434, and an N-type connection region 436. These storage regions 431 and 432, sensitivity regions 433 and 434, and N-type connection regions 435 and 436 are made of N-type semiconductors. The sensitivity regions 433 and 434 are larger in area than the storage regions 431 and 432. Further, as will be described in detail below with reference to FIGS. 5A to 5C, the storage regions 431 and 432 are formed at a first depth and the sensitivity regions 433 and 434 are formed at a second depth different from the first depth. In order to make the explanation easier to understand, a region where charges are mainly generated in response to incident light is called a “sensitivity region”, and a region where the generated charges are mainly accumulated is called a “storage region”. However, there is no clear division between the charge generation region and the charge storage region. Charges are also generated in the storage regions 431 and 432 according to the light that reaches there, and some of the generated charges remain in the sensitivity regions 433 and 434.

FIGS. 5A to 5C are diagrams schematically showing the basic cross-sectional structure of the pixel portion 113 on the PD substrate 101 side. FIG. 5A is a cross sectional schematic diagram taken along an A-A′ line of FIG. 4, FIG. 5B is a cross sectional schematic diagram taken along a B-B′ line of FIG. 4, and FIG. 5C is a cross sectional schematic diagram taken along a C-C′ line of FIG. 4. The PD substrate 101 has a first surface and a second surface opposite the first surface. The first surface is the front surface of the PD substrate 101 and the second surface is the back surface of the PD substrate 101. The direction from the first surface to the second surface is the positive direction of the Z direction. On the first surface (front surface) side of the PD substrate 101, gate electrodes of transistors, a multilayer wiring structure, and the like are arranged. In addition, on the second surface (back surface) side of the PD substrate 101, an optical structure such as a color filter 501 and the ML 421 that collectively cover the two photodiodes of each pixel is arranged, and light enters from the second surface (back surface) side.

As shown in FIG. 5A, the PD substrate 101 includes a P-type semiconductor region 500, the storage regions 431 and 432 and the sensitivity regions 433 and 434 surrounded by the P-type semiconductor region 500. The storage region 431 and sensitivity region 433 have different shapes in plan view, and so as the storage region 432 and sensitivity region 434, and partially overlap each other in plan view. Further, as described above, the storage regions 431 and 432 and the sensitivity regions 433 and 434 are arranged at different positions in the depth direction, and the storage regions 431 and 432 are located in the depth closer to the first surface side (first depth), and the sensitivity regions 433 and 434 are located in the depth closer to the second surface side (second depth). In the P-type semiconductor region 500, a storage isolation region 502 separates the storage regions 431 and 432, and a sensitivity isolation region 503 separates the sensitivity regions 433 and 434.

As shown in FIG. 5B, the storage region 431 and the sensitivity region 433 are connected in the depth direction via the N-type connection region 435. Further, as shown in FIG. 5C, the storage region 432 and the sensitivity region 434 are connected in depth direction via the N-type connection region 436.

In FIG. 5B, a region 504 is recessed in the Z direction by the P-type semiconductor in the storage region 431. This recessed region 504 suppresses charge being accumulated in an area, that overlaps with the N-type connection region 435 in plan view, on the first surface side of the storage region 431. As a result, when the signal charge accumulated in the storage region 431 of the PDA 201 is transferred to the FD 208, an amount of signal charge left in the storage region 431 after the transfer operation is suppressed. It should be noted that other methods such as lowering the impurity concentration of a portion of the storage region 431 may be used instead of the recessed region 504 as long as an amount of signal charge left in the storage region 431 can be suppressed.

Also, as shown in FIG. 5C, the lengths in the Z direction of the storage regions 431 and 432 are shorter than the lengths in the Z direction of the storage regions 431 and 432 in the cross sections shown in FIG. 5A and FIG. 5B, and a portion 505 by which the lengths of the storage regions 431 and 432 are shortened is formed of a P-type semiconductor. As a result, when the signal charge accumulated in the storage regions 431 and 432 are transferred to the FD 208, an amount of signal charge left in the storage regions 431 and 432 is suppressed.

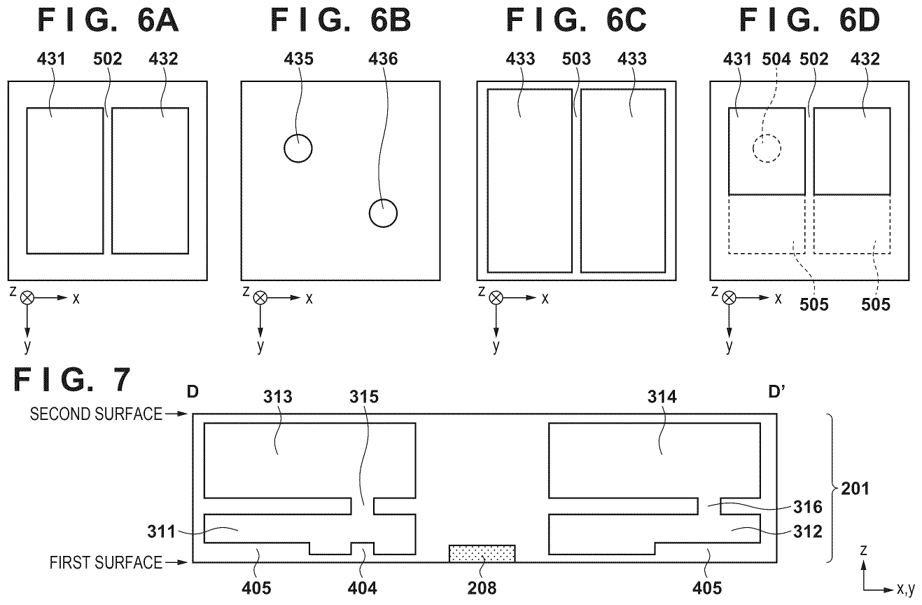

FIGS. 6A to 6D are diagrams schematically showing x-y cross sections of the PDA 201 and PDB 202 in different depths in the z direction. FIG. 6A is a cross-sectional diagram taken along an E-E′ line of FIGS. 5A to 5C, FIG. 6B is a cross-sectional diagram taken along an F-F′ line of FIGS. 5A to 5C, FIG. 6C is a cross-sectional diagram taken along a G-G′ line of FIGS. 5A to 5C, and FIG. 6D is a cross-sectional diagram taken along an H-H′ line of FIGS. 5A to 5C. As shown in FIG. 6D, in the partial regions of the storage regions 431 and 432 located away from the gate electrodes 403, 404, 405, and 406, as described with reference to FIG. 5C, the storage regions 431 and 432 are replaced by cutout portions 505 made of P-type semiconductor.

FIG. 7 is a diagram schematically showing a cross section taken along a D-D′ line of FIG. 4. The storage regions 431 and 432, the sensitivity regions 433 and 434, and the N-type connection regions 435 and 436 are shown in the same drawing along the D-D′ polygonal line of FIG. 4 on the x-y plane. During the accumulation period, when light is incident on the second surface of t the PD substrate 101 through the ML 421, electrons (signal charge) are generated mainly in the sensitivity regions 433 and 434 by photoelectric conversion. Most of the signal charge generated in the sensitivity region 433 moves to the storage region 431 through the N-type connection region 435 and is accumulated there. Also, most of the signal charge generated in the sensitivity region 434 moves to the storage region 432 through the N-type connection region 436 and is accumulated there. In order to realize signal charge transfer from the sensitivity region to the storage region, it is desirable that the potential that affects electrons monotonously decrease on the charge transfer path from the sensitivity region to the storage region.

### Horizontally Divided Pixels and Vertically Divided Pixels

Since the storage regions and the sensitivity regions are arranged at different depths, the layout direction of the sensitivity regions of the PDA 201 can be made different from that of the PDB 202 while keeping the positions of the transistors of the pixel portion 113 on the PD substrate 101 side. The layout directions of the sensitivity regions of the PDA 201 and PDB 202 may be differed with the positions of the transistors of the pixel portion 113 on the PD substrate 101 side being changed.

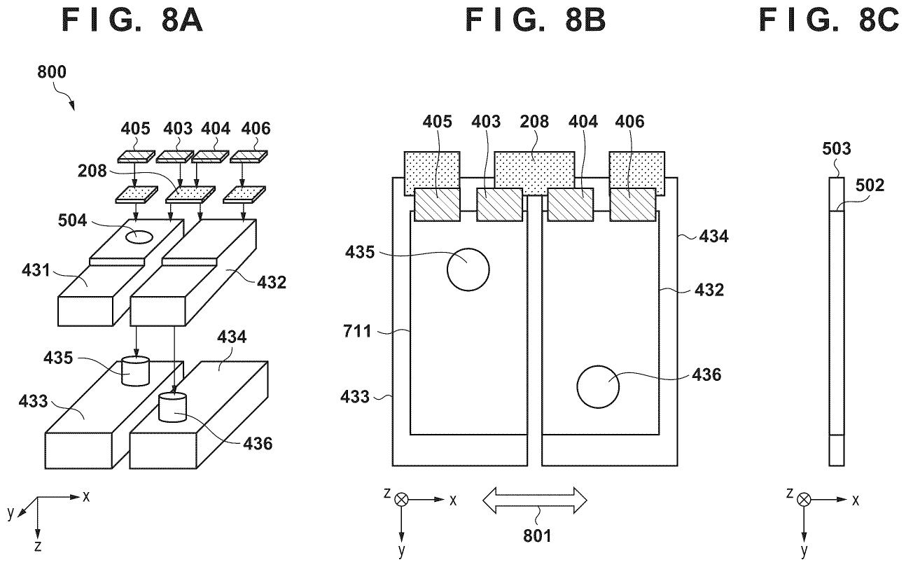

FIGS. 8A to 8C show a pixel 800 having the layout in which the sensitivity regions are horizontally divided (referred to as “horizontal division layout”, hereinafter) in the pixel portion 113 on the PD substrate 101 side, and correspond to one of an R pixel, a B pixel, and a G pixel in a Bayer arrangement to be described later.

FIG. 8A is an exploded perspective view of the storage regions 431 and 432, sensitivity regions 433 and 434, N-type connection regions 435 and 436, gate electrode 403 of the TXA 203, gate electrode 404 of the TXB 204, gate electrode 405 of the OFGA 205, gate electrode 406 of the OFGB 206, and FD 208 in the horizontal division layout. In the horizontal division layout, the storage regions 431 and 432 and the sensitivity regions 433 and 434 all extend in the y direction, i.e., the same direction.

FIG. 8B is a schematic plan view showing the positional relationship between the storage regions 431 and 432, sensitivity regions 433 and 434, N-type connection regions 435 and 436, gate electrode 403 of the TXA 203, gate electrode 404 of the TXB 204, gate electrode 405 of the OFGA 205, gate electrode 406 of the OFGB 206, and FD 208 in the horizontal division layout in plan view. In the horizontal division layout, since the sensitivity regions 433 and 434 in which charge is generated by photoelectric conversion are arranged in the x direction, it is possible to obtain phase difference signals in which the pupil division direction is the x direction. Reference numeral 801 indicates the division direction of the phase difference signals.

FIG. 8C is a schematic plan view showing the positional relationship between the storage isolation region 502 and the sensitivity isolation region 503 in the horizontal division layout in plan view. In the horizontal division layout, both the storage isolation region 502 and the sensitivity isolation region 503 extend in the y direction.

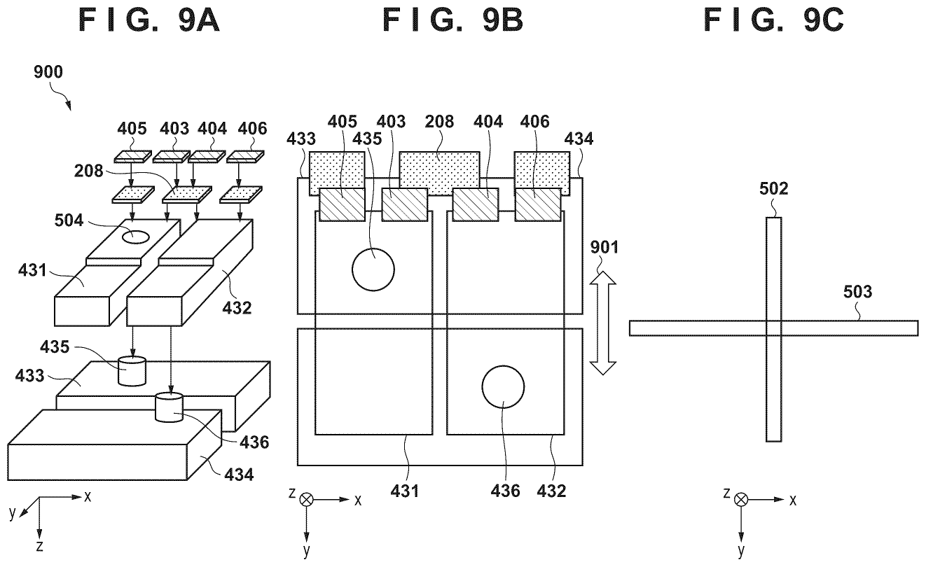

FIGS. 9A to 9C show a pixel 900 having the layout in which the sensitivity regions are vertically divided (referred to as “vertical division layout”, hereinafter) in the pixel portion 113 on the PD substrate 101 side, and correspond to one of G pixels in a Bayer arrangement to be described later.

FIG. 9A is an exploded perspective view of the storage regions 431 and 432, sensitivity regions 433 and 434, N-type connection regions 435 and 436, gate electrode 403 of the TXA 203, gate electrode 404 of the TXB 204, gate electrode 405 of the OFGA 205, gate electrode 406 of the OFGB 206, and FD 208 in the vertical division layout. In the vertical division layout, the storage regions 431 and 432 extend in the y direction and the sensitivity regions 433 and 434 extend in the x direction, which are orthogonal in plan view, i.e., in different directions.

FIG. 9B is a schematic plan view showing the positional relationship between the storage regions 431 and 432, sensitivity regions 433 and 434, N-type connection regions 435 and 436, gate electrode 403 of the TXA 203, gate electrode 404 of the TXB 204, gate electrode 405 of the OFGA 205, gate electrode 406 of the OFGB 206, and FD 208 in the vertical division layout in plan view. In the vertical division layout, since the sensitivity regions 433 and 434 in which charge is generated by photoelectric conversion are arranged in the y direction, it is possible to obtain phase difference signals in which the pupil division direction is the y direction. Reference numeral 901 indicates the division direction of the phase difference signals.

FIG. 9C is a schematic plan view showing the positional relationship between the storage isolation region 502 and the sensitivity isolation region 503 in the vertical division layout in plan view. In the vertical division layout, the storage isolation region 502 extends in the y direction and the sensitivity isolation region 503 extends in the x direction.

[arrangement of Horizontally Divided Pixels, Vertically Divided Pixels, and Color Filters]

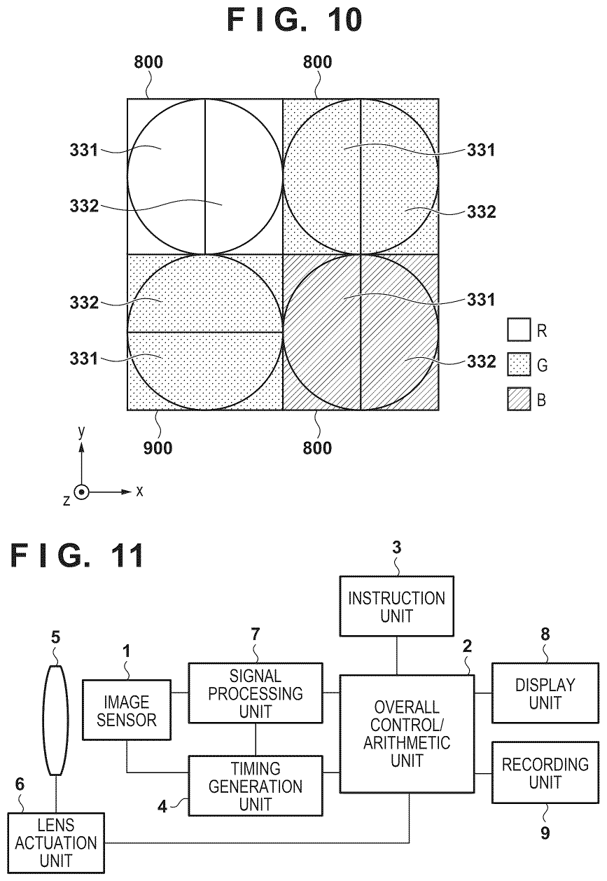

FIG. 10 is a diagram schematically showing the arrangement of sensitivity regions of the pixel 800 having the horizontal division layout (referred to as “horizontally divided pixels”, hereinafter) and the pixel 900 having the vertical division layout (referred to as “vertically divided pixels”, hereinafter), and the color filter 501 in the present embodiment in a range of 2×2 pixels.

The horizontally divided pixel 800 with a color filter having R (red) spectral sensitivity is arranged on the upper left, the horizontally divided pixel 800 with the color filter having G (green) spectral sensitivity is arranged on the upper right, the vertically divided pixel 900 with the color filter having G (green) spectral sensitivity is arranged on the lower left, and the horizontally divided pixel 800 with the color filter having B (blue) spectral sensitivity is arranged on the lower right, and thus the arrangement of the color filters is Bayer arrangement.

The 2-row×2-column arrangement (unit) shown in FIG. 10 is extended over the entire pixel array, thereby the phase difference signals with the pupil division direction in the horizontal direction and the phase difference signals with the pupil division direction in the vertical direction can be obtained in the entire area of the pixel array.

Further, since horizontal phase difference signals are obtained for each of the pixels with R, G, and B color filters, horizontal phase difference signals can be obtained regardless of the color of the object. In addition, the phase difference signals in the vertical direction are obtained from the pixels with G color filter, which has the highest transmittance among R, G, and B color filters, so the accuracy of the obtained phase difference signals is higher comparing to a case where the phase difference signals are obtained from the pixels with R color filter or B color filter.

### [Overall Configuration of Image Capturing Apparatus]

FIG. 11 is a block diagram showing a schematic configuration of an image capturing apparatus according to the present embodiment. The image capturing apparatus of the present embodiment includes an image sensor 100 having the configuration as described above, an overall control/arithmetic unit 2, an instruction unit 3, a timing generation unit 4, an imaging lens unit 5, a lens actuation unit 6, a signal processing unit 7, a display unit 8 and a recording unit 9.

The imaging lens unit 5 forms an optical image of a subject on the image sensor 100. Although it is represented by one lens in the figure, the imaging lens unit 5 may include a plurality of lenses including a focus lens, a zoom lens, and so on, and a diaphragm, and may be detachable from the main body of the image capturing apparatus or may be integrally configured with the main body.

The image sensor 100 has the configuration as described in the above embodiment, converts the light incident through the imaging lens unit 5 into electric signals and outputs them. Signals are read out from each pixel of the image sensor 100 so that pupil division signals that can be used in phase difference focus detection and an image signal that is a signal of each pixel can be acquired.

The signal processing unit 7 performs predetermined signal processing such as correction processing on the signals output from the image sensor 100, and outputs the pupil division signals used for focus detection and the image signal used for recording.

The overall control/arithmetic unit 2 comprehensively actuates and controls the entire image capturing apparatus. In addition, the overall control/arithmetic unit 2 also performs calculations for focus detection using the pupil division signals processed by signal processing unit 7, and performs arithmetic processing for exposure control, and predetermined signal processing, such as development for generating images for recording/playback and compression, on the image signal.

The lens actuation unit 6 actuates the imaging lens unit 5, and performs focus control, zoom control, aperture control, and the like on the imaging lens unit 5 according to control signals from the overall control/arithmetic unit 2.

The instruction unit 3 receives inputs such as shooting execution instructions, actuation mode settings for the image capturing apparatus, and other various settings and selections that are input by the operation of the user, for example, and sends them to the overall control/arithmetic unit 2.

The timing generation unit 4 generates a timing signal for actuating the image sensor 100 and the signal processing unit 7 according to a control signal from the overall control/arithmetic unit 2.

The display unit 8 displays a preview image, a playback image, and information such as the actuation mode settings of the image capturing apparatus.

The recording unit 9 is provided with a recording medium (not shown), and records an image signal for recording. Examples of the recording medium include semiconductor memories such as flash memory. The recording medium may be detachable from the recording unit 9 or may be built-in.

### [Calculation of Defocus Amount]

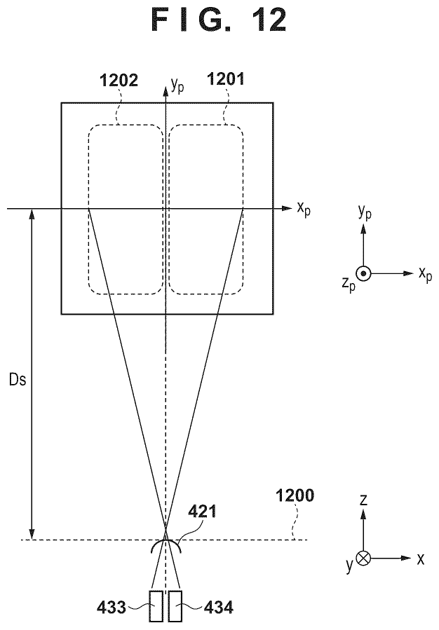

Next, a calculation method for calculating a defocus amount from the pupil division signals in the overall control/arithmetic unit 2 will be described with reference to FIGS. 12 to 15. Since the calculation for calculating the defocus amount from the horizontal phase difference signals and the calculation for calculating the defocus amount from the vertical phase difference signals are the same in principle, a case where the defocus amount is calculated from the horizontal phase difference signals will be explained here.

FIG. 12 is a horizontal cross-sectional view of the horizontally divided pixels 800 whose division direction is horizontal and a pupil plane at the position separated from an imaging plane 1200 of the image sensor 100 by a distance Ds in the negative direction of the z-axis.

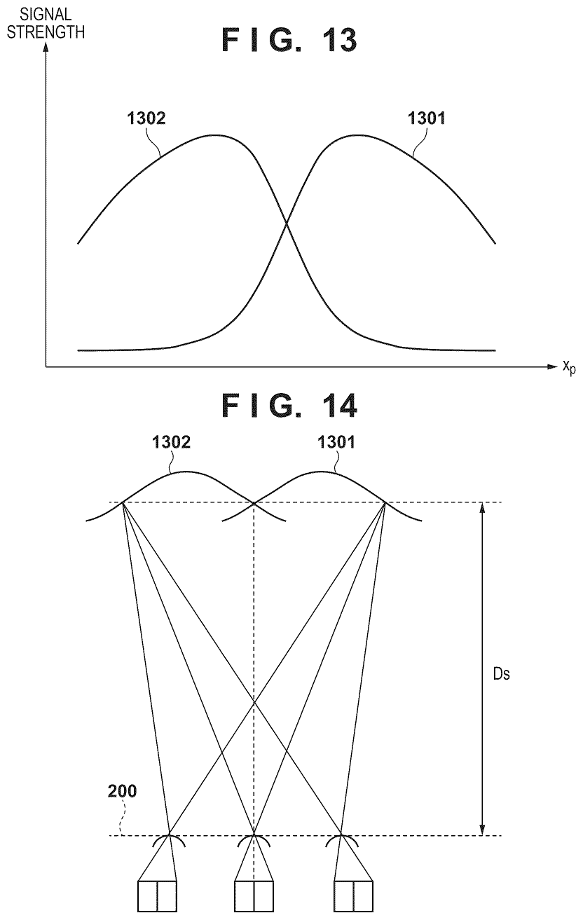

The pupil plane and the light receiving surface (second surface) of the image sensor 100 have substantially conjugated relationship via the ML 421. Therefore, the luminous flux that has passed through a partial pupil region 1201 is mostly received in the sensitivity region 433 (PDA 201). Further, the luminous flux that has passed through a partial pupil region 1202 is mostly received in the sensitivity region 434 (PDB 202). Signal charges photoelectrically converted near the boundary between the sensitivity regions 433 and 434 are stochastically transported to the storage region 431 or the storage region 432. Accordingly, at the boundary between the partial pupil region 1201 and the partial pupil region 1202, the signal gradually switches as the x coordinate increases, and the x direction dependency of the pupil intensity distribution has a shape as illustrated in FIG. 13. Here, the pupil intensity distribution corresponding to the PDA 201 is referred to as a first pupil intensity distribution 1301, and the pupil intensity distribution corresponding to the PDB 202 is referred to as a second pupil intensity distribution 1302.

Next, with reference to FIG. 14, a sensor entrance pupil of the image sensor 100 will be described. In the image sensor 100 of the present embodiment, the MLs 421 of respective pixels are continuously shifted toward the center of the image sensor 100 depending on the image height coordinates of the pixels on the two-dimensional plane. That is, each ML 421 is arranged so as to be more eccentric toward the center as the image height of the pixel becomes higher. The center of the image sensor 100 and the optical axis of the imaging optical system are shifted by the mechanism that reduces the influence of blurring due to camera shake or the like by moving the imaging optical system or the image sensor 100, but they are substantially the same. As a result, in the pupil plane located at a distance Ds from the image sensor 100, the first pupil intensity distribution 1301 and the second pupil intensity distribution 1302 of horizontally divided pixels 800 arranged at different image height of the image sensor 100 substantially match.

Hereinafter, the first pupil intensity distribution 1301 and the second pupil intensity distribution 1302 are called the “sensor entrance pupil” of the image sensor 100, and the distance Ds is called the “entrance pupil distance” of the image sensor 100. It should be noted that it is not necessary to configure all pixels to have a single entrance pupil distance. For example, the pixels located at up to 80% of image height may have substantially the same entrance pupil distance, or the pixels in different rows or in different detection areas may be configured to have different entrance pupil distances.

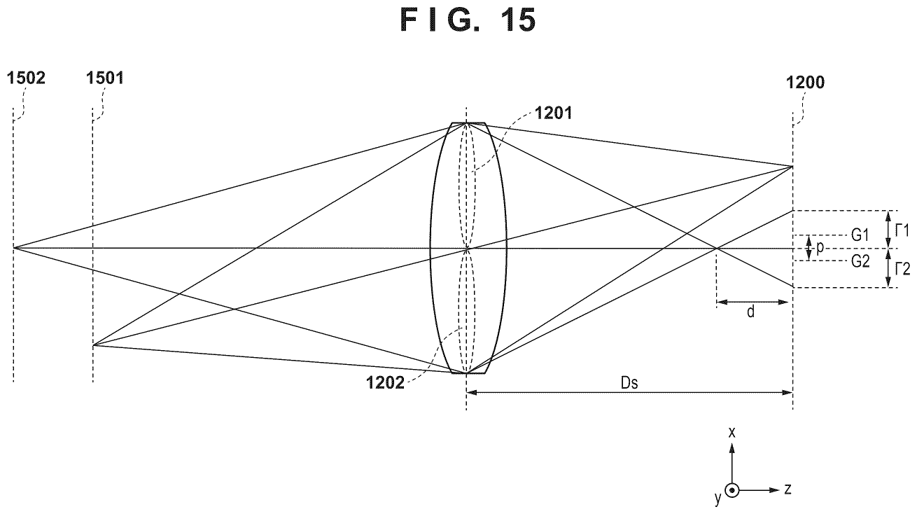

FIG. 15 shows a schematic relationship diagram between an image shift amount and a defocus amount between parallax images. The image sensor 100 (not shown) of the present embodiment is aligned on the imaging plane 1200, and the exit pupil of the imaging optical system is divided into the partial pupil region 1201 and the partial pupil region 1202 as in FIG. 12.

For a defocus amount d, the magnitude of the distance from the imaging position of the subject to the imaging plane is given by |d|, the front focused state in which the in-focus position of the subject is on the subject side with respect to the imaging plane is expressed by negative (d<0), and the rear focused state in which the in-focus position of the subject is on the opposite side of the subject with respect to the imaging plane is expressed by positive (d>0). The in-focus state in which the in-focus position of the subject is on the imaging plane is expressed as d=0. FIG. 15 shows an example in which a subject on an object plane 1501 is in the in-focus state (d=0) and a subject on an object plane 1502 is in the front focused state (d<0). The front focused state (d<0) and the rear focused state (d>0) are both referred to as a defocus state (|d|>0).

In the front focused state (d<0), among the luminous fluxes from the subject on the object plane 1502, the luminous flux that has passed through the partial pupil region 1201 (1202) converges once and then diverges to have the radius Γ1 (Γ2) about the position G1 (G2) as the center of gravity of the luminous flux, and formed as a blurred image on the imaging plane 1200. The blurred image is received by the sensitivity region 433 (PDA 201) and the sensitivity region 434 (PDB 202), and parallax images are generated. Therefore, the generated parallax images are of a blurred image of the subject with the subject on the object plane 1502 being spread to have the radius Γ1 (Γ2) about the position G1 (G2) of the center of gravity.

The radius Γ1 (Γ2) of blur of the subject image generally increases proportionally as the magnitude |d| of the defocus amount d increases. Similarly, the magnitude |p| of an image shift amount p (=G2−G1) between the subject images of the parallax images also increases approximately proportionally as the magnitude |d| of the defocus amount d increases. The same relationship holds in the rear focused state (d>0), although the image shift direction of the subject images between the parallax images is opposite to that in the front focused state. In the in-focus state (d=0), the positions of the centers of gravity of the subject images in the parallax images are the same (p=0), and no image shift occurs.

Therefore, with regard to the two phase difference signals obtained by using the signals from the sensitivity region 433 (PDA 201) and the sensitivity region 434 (PDB 202), as the magnitude of the defocus amount of the parallax images increases, the magnitude of the image shift amount between the two phase difference signals in the x direction increases. Based on this relationship, the phase difference focus detection is performed by converting the image shift amount calculated by performing correlation operation on the image shift amount between the parallax images in the x direction into the defocus amount.

### [Vertically Divided Pixels and Horizontally Divided Pixels in Calculating Defocus Amount]

In the calculation of the defocus amount described above, it is necessary to calculate an image shift amount. To calculate the image shift amount, two phase difference signals (signal obtained from the PDA 201 and signal obtained from PDB 202) should be compared at different position in the pupil-division direction. Therefore, in order to calculate the image shift amount in the vertical direction, it is necessary to compare phase difference signals between different rows. When the image sensor 100 is actuated using a rolling shutter method, for example, instead of a global shutter method, timing of exposure is different in different rows, and there is a possibility that the accuracy of the phase difference detection in the vertical direction may be lower than that of the phase difference detection in the horizontal direction. On the other hand, in the present embodiment, it is possible to suppress deterioration in accuracy of phase difference detection in the vertical direction due to the accumulation timing difference.

By configuring as described above, it is possible to achieve both high-speed readout and acquisition of highly simultaneous vertical/horizontal phase difference signals in an image sensor.

### Second Embodiment

Next, a second embodiment of the present invention will be described.

In the first embodiment described above, a configuration in which the image sensor 100 includes two frame memories has been described. However, the present invention is not limited to this, and a configuration in which the image sensor includes three frame memories may be employed. In the second embodiment, differences from the first embodiment will be mainly described, using a configuration in which the image sensor includes three frame memories as an example.

### [Configuration of Image Sensor]

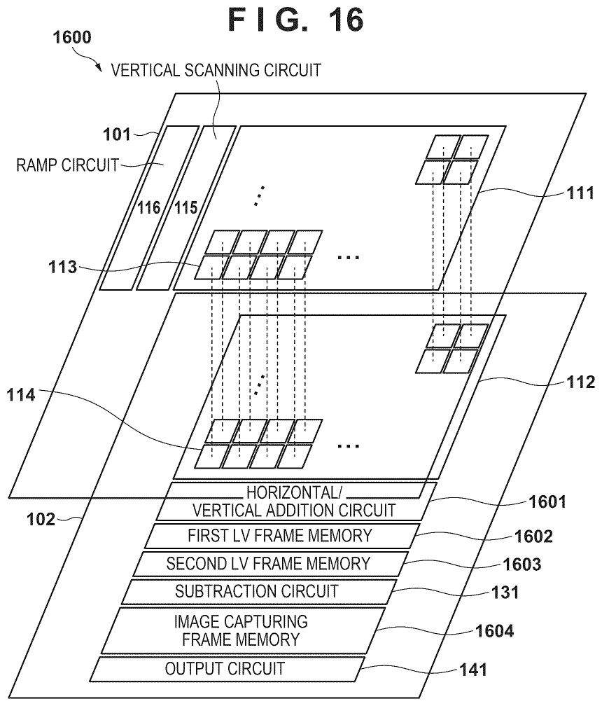

FIG. 16 is a diagram schematically showing the overall configuration of an image sensor 1600 according to the second embodiment of the present invention. The image sensor 1600 does not include the N signal frame memory 121 and the A/A+B signal frame memory 122 and includes a horizontal/vertical (HV) addition circuit 1601, a first live view (LV) frame memory 1602, a second LV frame memory 1603, and an image capturing frame memory 1604, as compared with the image sensor 100. The N signal frame memory 121 and the A/A+B signal frame memory 122 of the image sensor 100 included memories corresponding to the number of pixels. While the image capturing frame memory 1604 of the image sensor 1600 includes memories corresponding to the number of pixels, the first LV frame memory 1602 and the second LV frame memory 1603 include memories corresponding to a quotient obtained by dividing the number of pixels by a number added in the HV addition circuit 1601.

### [Live View Operation]

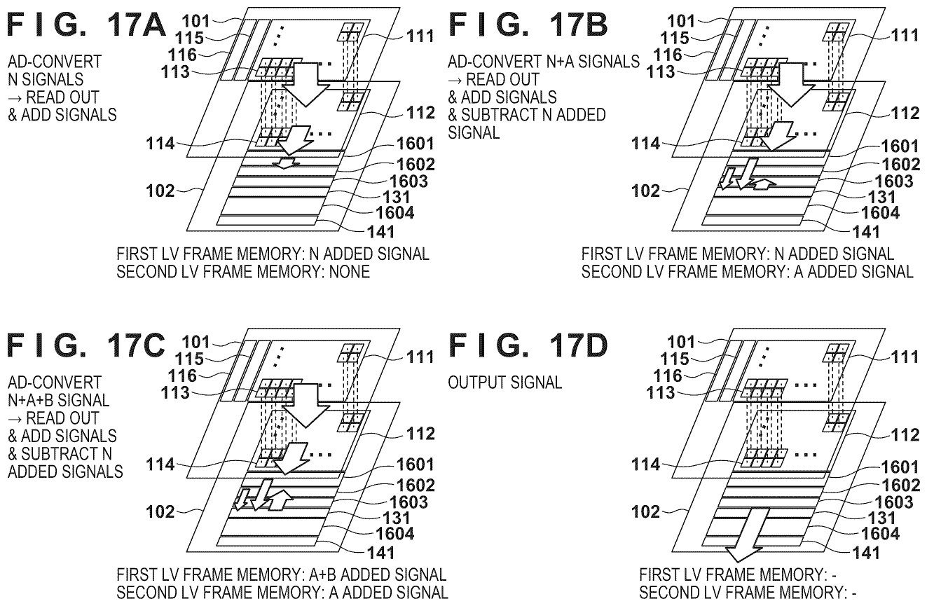

FIGS. 17A to 17D are diagrams schematically showing a flow of LV signal readout according to the second embodiment and operations are performed in the order of FIGS. 17A to 17D. In each drawing, general operations are indicated on the upper side of the overall configuration of the image sensor 1600, a flow of signals/operating circuit blocks is indicated using arrows/in an emphasized manner using text on the overall configuration of the image sensor 1600, and the type of signals held in the first LV frame memory 1602 and the second LV frame memory 1603 after completion of each operation are indicated on the lower side of the overall configuration of the image sensor 1600. Hereinafter, a live view signal readout operation will be described with reference to FIGS. 17A to 17D. This read operation is not limited to live view, and may be a low-resolution moving image readout operation or a still image readout operation.

First, as shown in FIG. 17A, the N signals are AD-converted, the results are sequentially read out from the pixel array and added by the HV addition circuit 1601, and the addition result (added noise signal) is outputted to and held in the first LV frame memory 1602. Here, signals of all the pixels are read out from the pixel array and added by the HV addition circuit 1601 but instead of adding them, some may be thinned out at a predetermined interval, or instead of using the HV addition circuit 1601, signals may be thinned out and read out at a predetermined interval and outputted to and held in the first LV frame memory 1602. An N added signal obtained by HV-adding the N signals is held in the first LV frame memory 1602.

Next, as shown in FIG. 17B, the N+A signals are AD-converted, and the results are sequentially read out from the pixel array and added by the HV addition circuit 1601 and outputted to and held in the subtraction circuit 131. At the same time, a corresponding N added signal is outputted from the first LV frame memory 1602 to the subtraction circuit 131, and the result of the subtraction is held in the second LV frame memory 1603. Thus, an A added signal is held in the second LV frame memory 1603.

Next, as shown in FIG. 17C, the N+A+B signals are AD-converted, and the results are sequentially read out from the pixel array and added by the HV addition circuit 1601 and outputted to the subtraction circuit 131. At the same time, a corresponding N added signal is outputted from the first LV frame memory 1602 to the subtraction circuit 131, and the result of the subtraction is outputted to the first LV frame memory 1602 and, for each group of added pixels, is sequentially held in the memory in which the N added signal had been held. By this operation, the signal held in the first LV frame memory 1602 is rewritten from the N added signal to the A+B added signal.

Next, as shown in FIG. 17D, the A+B added signal held in the first LV frame memory 1602 and the A added signal held in the second LV frame memory 1603 are outputted from the chip.

### [Image Capturing Operation]

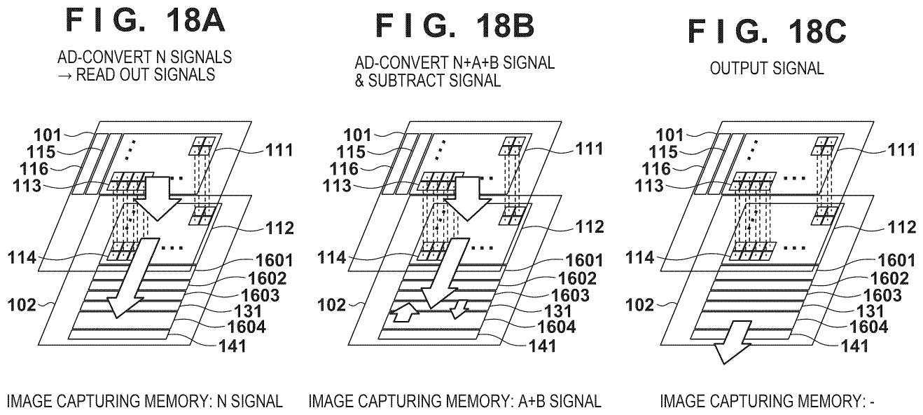

FIGS. 18A to 18C are diagrams schematically showing image signal readout processing according to the second embodiment and operations are performed in the order of FIGS. 18A to 18C. The indications in the respective drawings are similar to those of FIGS. 17A to 17D. Hereinafter, an image signal (image signal for recording) readout operation will be described with reference to FIGS. 18A to 18C.

First, as shown in FIG. 18A, the N signals are AD-converted, and the results are sequentially outputted from the pixel array to the image capturing frame memory 1604, and held.

Next, as shown in FIG. 18B, the N+A+B signals are AD-converted, and the results are sequentially read out from the pixel array and outputted to the subtraction circuit 131. At the same time, a corresponding N signal is outputted from the image capturing frame memory 1604 to the subtraction circuit 131, and the result of the subtraction is held in the image capturing frame memory 1604. By this operation, the signal held in the image capturing frame memory 1604 is rewritten from the N signal to the A+B signal. Here, the N+A+B signal is AD-converted without AD-converting the N+A signal, and the N+A+B signal can be AD-converted without AD-converting the N+A signal by omitting t₃₀₈ to t₃₁₃ among detailed operation timings described in the first embodiment and turning the TXA 203 on and off at the timing the TXB 204 is turned on and off.

Next, as shown in FIG. 18C, the A+B signal held in the image capturing frame memory 1604 is outputted from the chip.

The time (t₃₀₂ to t₃₀₃) from when the OFGA 205 and the OFGB 206 are turned on and off to when the AD conversion operation is started may be made different such that the accumulation time is different between the live view operation and the image capturing operation.

As described above, by configuring three frame memories in the image sensor, the accumulation of the LV signal and the accumulation of the signal for recording a still image can be made independently controllable in the global shutter operation.

### Third Embodiment

Next, a third embodiment of the present invention will be described.

In the first and second embodiments described above, a configuration in which the image sensor 100 includes two frame memories and a configuration in which the image sensor 1600 includes three frame memories have been described. However, the present invention is not limited to this, and a configuration in which the image sensor includes four frame memories may be employed. In the third embodiment, a configuration in which an image sensor includes four frame memories will be described, focusing on differences from the first and second embodiment.

### [Configuration of Image Sensor]

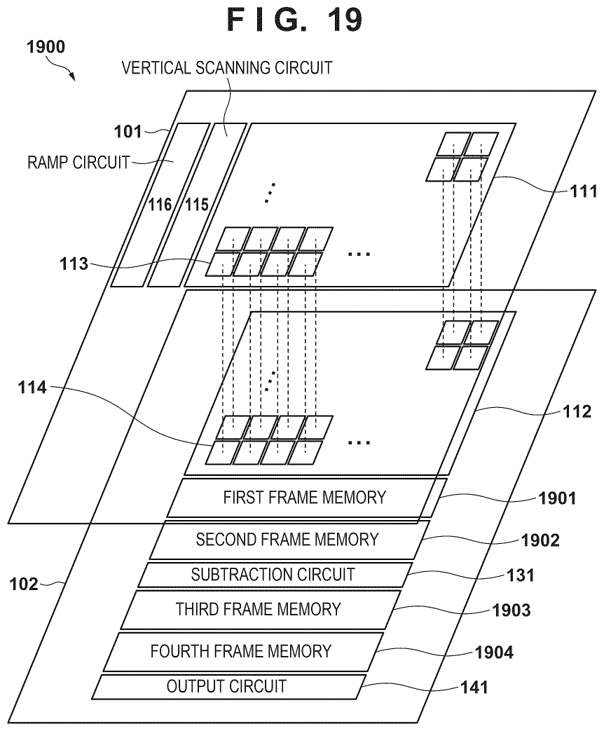

FIG. 19 is a diagram schematically showing the overall configuration of an image sensor 1900 according to the third embodiment of the present invention. The image sensor 1900 includes a first frame memory 1901, a second frame memory 1902, a third frame memory 1903, and a fourth frame memory 1904, each having the same number of memories as the number of pixels.

### [Image Capturing Operation/Live View Operation A]

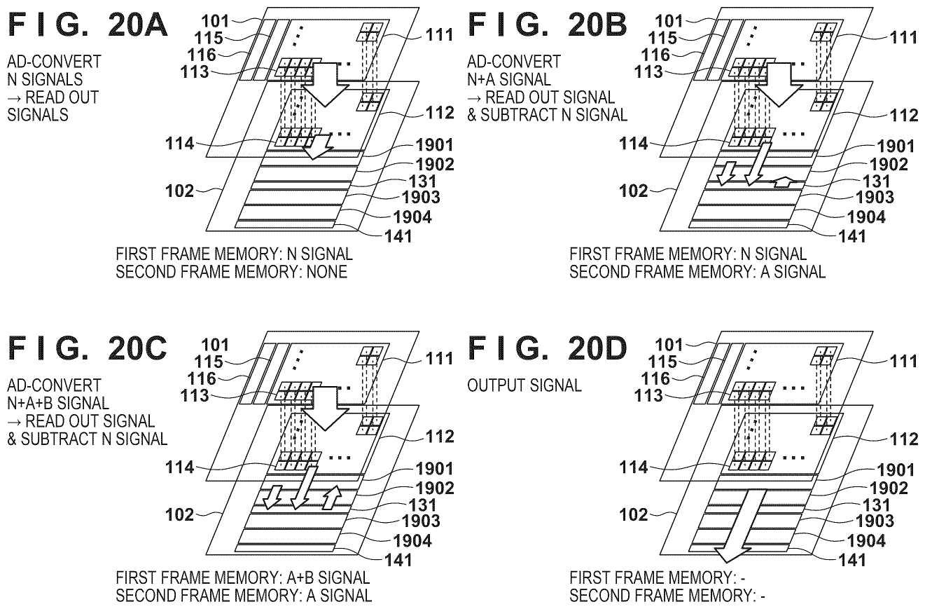

FIGS. 20A to 20D are diagrams schematically showing a readout flow of an image capturing operation/live view operation A according to the third embodiment, and operations are performed in the order of FIGS. 20A to 20D. The indications in the respective drawings are similar to those of FIGS. 17A to 17D and FIGS. 18A to 18C. Hereinafter, a readout operation of the image capturing operation/live view operation A will be described with reference to FIGS. 20A to 20D.

First, as shown in FIG. 20A, the N signals are AD-converted, and the results are sequentially read out from the pixel array, outputted to the first frame memory 1901, and held.

Next, as shown in FIG. 20B, the N+A signals are AD-converted, and the results are sequentially read out from the pixel array and outputted to the subtraction circuit 131. At the same time, a corresponding N signal is outputted from the first frame memory 1901 to the subtraction circuit 131, and the result of the subtraction is held in the second frame memory 1902. Thus, an A signal is held in the second frame memory 1902.

Next, as shown in FIG. 20C, the N+A+B signals are AD-converted, and the results are sequentially read out from the pixel array and outputted to the subtraction circuit 131. At the same time, a corresponding N signal is outputted from the first frame memory 1901 to the subtraction circuit 131, and the result of the subtraction is outputted to the first frame memory 1901 and, for each pixel, is sequentially held in the memory in which the N signal had been held. By this operation, the signal held in the first frame memory 1901 is rewritten from the N signal to the A+B signal.

Next, as shown in FIG. 20D, the A+B signal held in the first frame memory 1901 and the A signal held in the second frame memory 1902 are outputted from the chip.

The A signal and the A+B signal obtained by the image capturing operation/live view operation A are referred to as a first A signal and a first A+B signal, respectively.

### [Image Capturing Operation/Live View Operation B]

An image capturing operation/live view operation B perform similar operations using the third frame memory 1903 instead of the first frame memory 1901 of the image capturing operation/live view operation A and the fourth frame memory 1904 instead of the second frame memory 1902 of the image capturing operation/live view operation A.

The A signal and the A+B signal obtained by the image capturing operation/live view operation B are referred to as a second A signal and a second A+B signal, respectively.

### [Dynamic Range Expansion Synthesis]

The time (t₃₀₂ to t₃₀₃) from when the OFGA 205 and the OFGB 206 are turned on and off is made different such that the accumulation time of the image capturing operation/live view operation A becomes shorter than the accumulation time of the image capturing operation/live view operation B. The first A signal, the second A signal, the first A+B signal, and the second A+B signal with different exposure periods obtained in this way are adjusted in accordance with the accumulation time and synthesized in the overall control/arithmetic unit 2.

By configuring four frame memories and performing operations with different accumulation times as described above, it is possible to obtain a phase difference signal and an image signal with an expanded dynamic range in the global shutter operation.

### [Modification]

Next, a modification will be described. In the first and second embodiments described above, description has been given assuming that each pixel of the image sensor 100, 1600, or 1900 is the horizontally divided pixel 800 or the vertically divided pixel 900. However, the present invention is not limited to this, and may be composed of pixels with the number of divisions and the division method different from those illustrated in the drawings.

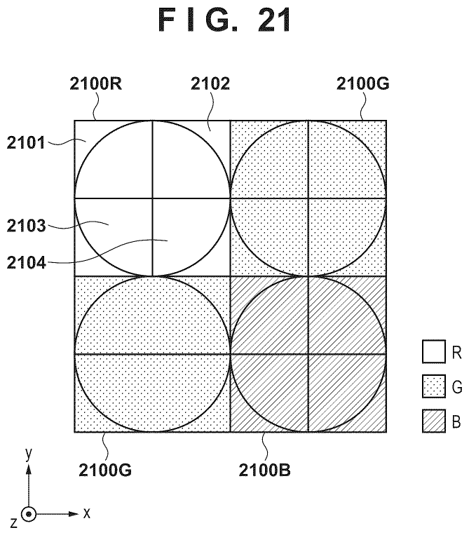

FIG. 21 is a diagram schematically showing sensitivity regions of a pixel 2100 and an arrangement of the color filter 501 in a range of 2×2 pixels in the present modification.

In the present modification, a pixel 2100R having R (red) spectral sensitivity is arranged on the upper left, the pixel 2100G having G (green) spectral sensitivity is arranged on the upper right and the lower left, the pixel 2100B having B (blue) spectral sensitivity is arranged on the lower right. Furthermore, each pixel is constituted by a first sensitivity region 2101 to a fourth sensitivity region 2104 in a 2-column×2-row arrangement. Therefore, in the present modification, there are four storage regions corresponding to the first sensitivity region 2101 to the fourth sensitivity region 2104.

The 2-row×2-column arrangement (unit) shown in FIG. 21 is extended over the entire pixel array. In such a configuration, it is possible to obtain a signal similar to that of the horizontally divided pixel 800 of FIG. 10 by adding the signals of the first sensitivity region 2101 and the third sensitivity region 2103 and adding the signals of the second sensitivity region 2102 and the fourth sensitivity region 2104 in the pixel, and reading them out. Further, it is possible to obtain a signal similar to that of the vertically divided pixel 900 of FIG. 10 by adding the received light signals of the first sensitivity region 2101 and the second sensitivity region 2102 and adding the received light signals of the third sensitivity region 2103 and the fourth sensitivity region 2104 in the pixel, and reading them out. When using as an image signal, the signals of the first to fourth sensitivity regions 2101 to 2104 need only be added. A pair of focus detection signals and an image signal may be obtained by reading out some of the signals of the first to fourth sensitivity regions 2101 to 2104 and a signal obtained by adding the first to fourth sensitivity regions 2101 to 2104 and subtracting the signals. Except for the above, it is similar to the embodiments described above.

Further, whether to perform actuation for obtaining a signal similar to that of the horizontally divided pixel 800 or actuation for obtaining a signal similar to that of the vertically divided pixel 900 may be controlled in accordance with the characteristics of the subject. For example, a configuration may be taken so as to perform actuation for obtaining a signal similar to that of the vertically divided pixel 900 when a luminance change in the horizontal direction is small, such as when the subject is wearing clothes with horizontal stripes, and actuation for obtaining a signal similar to that of the horizontally divided pixel 800 when a luminance change in the vertical direction is small, such as when the subject is wearing clothes with vertical stripes.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-154235, filed Sep. 6, 2024 which is hereby incorporated by reference herein in its entirety.

What is claimed is:

1. An image sensor comprising:
a pixel array in which a plurality of pixels are arranged; and
a first memory configured to hold signals outputted from the pixel array,
each of the plurality of pixels including:
a plurality of photoelectric conversion units that photoelectrically convert light that has passed through different pupil regions of an imaging optical system, and respectively output analog signals;
an analog-to-digital conversion unit that converts the analog signals outputted from the plurality of photoelectric conversion unit into digital signals; and
a latch unit that latches the digital signals converted by the analog-to-digital conversion unit,
wherein the first memory holds the digital signals latched by the latch unit.

2. The image sensor according to claim 1, further comprising:
an actuation unit that actuates the plurality of pixels,
wherein the actuation unit actuates the plurality of pixels so as to simultaneously output the analog signals to the analog-to-digital conversion unit.

3. The image sensor according to claim 2, wherein
the actuation unit actuates the plurality of pixels so as to output, from each the plurality of pixels, the analog signals such that a pair of focus detection signals having parallax in either a first direction or a second direction orthogonal to the first direction can be obtained.

4. The image sensor according to claim 3, wherein
each of the plurality of pixels is covered by a red, green, or blue color filter in a Bayer arrangement, and
the actuation unit actuates a pixel on which a red, green, or blue color filter is arranged among four color filters constituting a repeating unit of the Bayer arrangement such that a pair of focus detection signals having parallax in the first direction can be obtained, and actuate a pixel on which a green color filter is arranged such that a pair of focus detection signals having parallax in the second direction can be obtained.

5. The image sensor according to claim 2, further comprising:
a second memory that holds digital signals latched by latch unit; and
a subtraction unit,
wherein the subtraction unit is implemented by one or more processors, circuitry or a combination thereof.

6. The image sensor according to claim 5, wherein
a noise signal, which has been obtained by the analog-to-digital conversion unit converting an analog signal when each of the plurality of pixels is reset into a digital signal and has been latched by the latch unit, is held in the first memory,
a first signal obtained by the subtraction unit subtracting, from a signal, which has been obtained by the analog-to-digital conversion unit converting an analog signal outputted from part of the plurality of photoelectric conversion units of each of the plurality of pixels into a digital signal and has been latched by the latch unit, the noise signal, which is held in the first memory and corresponds to the same pixel, is held in the second memory, and
a second signal obtained by the subtraction unit subtracting, from a signal, which has been obtained by the analog-to-digital conversion unit converting an analog signal outputted from the plurality of photoelectric conversion units of each of the plurality of pixels and has been latched by the latch unit, the noise signal, which is held in the first memory and corresponds to the same pixel, is held in the first memory.

7. The image sensor according to claim 2, further comprising:
an addition unit that adds digital signals, which have been latched by latch unit, in units corresponding to a predetermined number of pixels;
a second memory and a third memory configured to hold added signals obtained by addition by the addition unit; and
a subtraction unit,
wherein the addition unit and the subtraction unit are implemented by one or more processors, circuitry or a combination thereof.

8. The image sensor according to claim 7, wherein
noise signals, each obtained by the analog-to-digital conversion unit converting an analog signal when each of the plurality of pixels is reset into a digital signal and latched by the latch unit, are added by the addition unit, and an added noise signal is held in the second memory,
a first signal obtained by the subtraction unit subtracting, from a signal obtained by the addition unit adding signals, each obtained by the analog-to-digital conversion unit converting an analog signal outputted from part of the plurality of photoelectric conversion units of each of the plurality of pixels into a digital signal and latched by the latch unit, the added noise signal, which is held in the second memory and corresponds to the same pixel, is held in the third memory, and
a second signal obtained by the subtraction unit subtracting, from a signal obtained by the addition unit adding signals, each obtained by the analog-to-digital conversion unit converting an analog signal outputted from the plurality of photoelectric conversion units of each of the plurality of pixels into a digital signal and latched by the latch unit, the added noise signal, which is held in the second memory and corresponds to the same pixel, is held in the second memory.

9. The image sensor according to claim 2, further comprising:
a second memory and a third memory configured to hold digital signals thinned out at a predetermined interval among digital signals corresponding to the plurality of pixels; and
a subtraction unit,
wherein the subtraction unit is implemented by one or more processors, circuitry or a combination thereof.

10. The image sensor according to claim 9, wherein
a thinned noise signal, which has been obtained by thinning out noise signals, each obtained by the analog-to-digital conversion unit converting an analog signal when each of the plurality of pixels is reset into a digital signal and latched by the latch unit, is held in the second memory,
a first signal obtained by the subtraction unit subtracting, from a signal obtained by thinning out signals, each obtained by the analog-to-digital conversion unit converting an analog signal outputted from part of the plurality of photoelectric conversion units of each of the plurality of pixels into a digital signal and latched by the latch unit, the thinned noise signal, which is held in the second memory and corresponds to the same pixel, is held in the third memory, and
a second signal obtained by the subtraction unit subtracting, from a signal obtained by thinning signals, each obtained by the analog-to-digital conversion unit converting an analog signal outputted from the plurality of photoelectric conversion units of each of the plurality of pixels into a digital signal and latched by the latch unit, the thinned noise signal, which is held in the second memory and corresponds to the same pixel, is held in the second memory.

11. The image sensor according to claim 7, wherein
a noise signal, which has been obtained by the analog-to-digital conversion unit converting an analog signal when each of the plurality of pixels is reset into a digital signal and has been latched by the latch unit, is held in the first memory,
a third signal obtained by the subtraction unit subtracting, from signals, which have been obtained by the analog-to-digital conversion unit converting analog signals respectively outputted from the plurality of photoelectric conversion units of each of the plurality of pixels into digital signals and have been latched by the latch unit, the noise signal, which is held in the first memory and corresponds to the same pixel, is held in the first memory.

12. The image sensor according to claim 9, wherein
a noise signal, which has been obtained by the analog-to-digital conversion unit converting an analog signal when each of the plurality of pixels is reset into a digital signal and has been latched by the latch unit, is held in the first memory,
a third signal obtained by the subtraction unit subtracting, from signals, which have been obtained by the analog-to-digital conversion unit converting analog signals respectively outputted from the plurality of photoelectric conversion units of each of the plurality of pixels into digital signals and have been latched by the latch unit, the noise signal, which is held in the first memory and corresponds to the same pixel, is held in the first memory.

13. The image sensor according to claim 2, further comprising:
a second memory, a third memory, and a fourth memory configured to hold digital signals latched by latch unit; and
a subtraction unit,
wherein the subtraction unit is implemented by one or more processors, circuitry or a combination thereof.

14. The image sensor according to claim 13, wherein
a noise signal, which has been obtained by the analog-to-digital conversion unit converting an analog signal when each of the plurality of pixels is reset into a digital signal and has been latched by the latch unit, is held in the first memory,
a first signal obtained by the subtraction unit subtracting, from a signal, which has been obtained by the analog-to-digital conversion unit converting an analog signal outputted from part of the plurality of photoelectric conversion units of each of the plurality of pixels after the plurality of photoelectric conversion units have been exposed for a predetermined first exposure period into a digital signal and has been latched by the latch unit, the noise signal, which is held in the first memory and corresponds to the same pixel, is held in the second memory, and
a second signal obtained by the subtraction unit subtracting, from a signal, which has been obtained by the analog-to-digital conversion unit converting an analog signal outputted from the plurality of photoelectric conversion units of each of the plurality of pixels after the first signal is held in the second memory into a digital signal and has been latched by the latch unit, the noise signal, which is held in the first memory and corresponds to the same pixel, is held in the first memory,
a noise signal, which has been obtained by the analog-to-digital conversion unit converting an analog signal when each of the plurality of pixels is reset after the second signal is held in the first memory into a digital signal and has been latched by the latch unit, is held in the third memory,
a third signal obtained by the subtraction unit subtracting, from a signal, which has been obtained by the analog-to-digital conversion unit converting an analog signal outputted from part of the plurality of photoelectric conversion units of each of the plurality of pixels after the plurality of photoelectric conversion units have been exposed for a predetermined second exposure period, which is different from the first exposure period, into a digital signal and has been latched by the latch unit, the noise signal, which is held in the third memory and corresponds to the same pixel, is held in the fourth memory, and
a fourth signal obtained by the subtraction unit subtracting, from a signal, which has been obtained by the analog-to-digital conversion unit converting an analog signal outputted from the plurality of photoelectric conversion units of each of the plurality of pixels after the third signal is held in the fourth memory into a digital signal and has been latched by the latch unit, the noise signal, which is held in the third memory and corresponds to the same pixel, is held in the third memory.

15. The image sensor according to according claim 1, wherein
the plurality of photoelectric conversion units and part of a configuration of the analog-to-digital conversion unit are configured on a first substrate,
a configuration of the analog-to-digital conversion unit that excludes the part, the latch unit, and the first memory are configured on a second substrate, and
the first substrate and the second substrate are stacked.

16. An image capturing apparatus comprising:
an image sensor that comprises:
a pixel array in which a plurality of pixels are arranged; and
a first memory configured to hold signals outputted from the pixel array,
each of the plurality of pixels including:
a plurality of photoelectric conversion units that photoelectrically convert light that has passed through different pupil regions of an imaging optical system, and respectively output analog signals;
an analog-to-digital conversion unit that converts the analog signals outputted from the plurality of photoelectric conversion unit into digital signals; and
a latch unit that latches the digital signals converted by the analog-to-digital conversion unit;
an actuation unit that actuates the plurality of pixels;
a second memory that holds digital signals latched by latch unit; and
a subtraction unit; and
a focus detection unit that performs phase difference focus detection by using the pair of focus detection signals having parallax, obtained from the first signal and the second signal,
wherein the first memory holds the digital signals latched by the latch unit,
the actuation unit actuates the plurality of pixels so as to simultaneously output the analog signals to the analog-to-digital conversion unit,
a noise signal, which has been obtained by the analog-to-digital conversion unit converting an analog signal when each of the plurality of pixels is reset into a digital signal and has been latched by the latch unit, is held in the first memory,
a first signal obtained by the subtraction unit subtracting, from a signal, which has been obtained by the analog-to-digital conversion unit converting an analog signal outputted from part of the plurality of photoelectric conversion units of each of the plurality of pixels into a digital signal and has been latched by the latch unit, the noise signal, which is held in the first memory and corresponds to the same pixel, is held in the second memory, and
a second signal obtained by the subtraction unit subtracting, from a signal, which has been obtained by the analog-to-digital conversion unit converting an analog signal outputted from the plurality of photoelectric conversion units of each of the plurality of pixels and has been latched by the latch unit, the noise signal, which is held in the first memory and corresponds to the same pixel, is held in the first memory, and
the subtraction unit is implemented by one or more processors, circuitry or a combination thereof.

17. An image capturing apparatus comprising:
an image sensor that comprises:
a pixel array in which a plurality of pixels are arranged; and
a first memory configured to hold signals outputted from the pixel array,
each of the plurality of pixels including:
a plurality of photoelectric conversion units that photoelectrically convert light that has passed through different pupil regions of an imaging optical system, and respectively output analog signals;
an analog-to-digital conversion unit that converts the analog signals outputted from the plurality of photoelectric conversion unit into digital signals; and
a latch unit that latches the digital signals converted by the analog-to-digital conversion unit;
an actuation unit that actuates the plurality of pixels;
an addition unit that adds digital signals, which have been latched by latch unit, in units corresponding to a predetermined number of pixels;
a second memory and a third memory configured to hold added signals obtained by addition by the addition unit; and
a subtraction unit; and
a focus detection unit that performs phase difference focus detection by using the pair of focus detection signals having parallax, obtained from the first signal and the second signal,
wherein the first memory holds the digital signals latched by the latch unit,
the actuation unit actuates the plurality of pixels so as to simultaneously output the analog signals to the analog-to-digital conversion unit,
noise signals, each obtained by the analog-to-digital conversion unit converting an analog signal when each of the plurality of pixels is reset into a digital signal and latched by the latch unit, are added by the addition unit, and an added noise signal is held in the second memory,
a first signal obtained by the subtraction unit subtracting, from a signal obtained by the addition unit adding signals, each obtained by the analog-to-digital conversion unit converting an analog signal outputted from part of the plurality of photoelectric conversion units of each of the plurality of pixels into a digital signal and latched by the latch unit, the added noise signal, which is held in the second memory and corresponds to the same pixel, is held in the third memory,
a second signal obtained by the subtraction unit subtracting, from a signal obtained by the addition unit adding signals, each obtained by the analog-to-digital conversion unit converting an analog signal outputted from the plurality of photoelectric conversion units of each of the plurality of pixels into a digital signal and latched by the latch unit, the added noise signal, which is held in the second memory and corresponds to the same pixel, is held in the second memory, and
the addition unit and the subtraction unit are implemented by one or more processors, circuitry or a combination thereof.

18. An image capturing apparatus comprising:
an image sensor that comprises:
a pixel array in which a plurality of pixels are arranged; and
a first memory configured to hold signals outputted from the pixel array,
each of the plurality of pixels including:
a plurality of photoelectric conversion units that photoelectrically convert light that has passed through different pupil regions of an imaging optical system, and respectively output analog signals;
an analog-to-digital conversion unit that converts the analog signals outputted from the plurality of photoelectric conversion unit into digital signals; and
a latch unit that latches the digital signals converted by the analog-to-digital conversion unit;
an actuation unit that actuates the plurality of pixels;
a second memory and a third memory configured to hold digital signals thinned out at a predetermined interval among digital signals corresponding to the plurality of pixels; and
a subtraction unit; and
a focus detection unit that performs phase difference focus detection by using the pair of focus detection signals having parallax, obtained from the first signal and the second signal,
wherein the first memory holds the digital signals latched by the latch unit,
the actuation unit actuates the plurality of pixels so as to simultaneously output the analog signals to the analog-to-digital conversion unit,
a thinned noise signal, which has been obtained by thinning out noise signals, each obtained by the analog-to-digital conversion unit converting an analog signal when each of the plurality of pixels is reset into a digital signal and latched by the latch unit, is held in the second memory,
a first signal obtained by the subtraction unit subtracting, from a signal obtained by thinning out signals, each obtained by the analog-to-digital conversion unit converting an analog signal outputted from part of the plurality of photoelectric conversion units of each of the plurality of pixels into a digital signal and latched by the latch unit, the thinned noise signal, which is held in the second memory and corresponds to the same pixel, is held in the third memory,
a second signal obtained by the subtraction unit subtracting, from a signal obtained by thinning signals, each obtained by the analog-to-digital conversion unit converting an analog signal outputted from the plurality of photoelectric conversion units of each of the plurality of pixels into a digital signal and latched by the latch unit, the thinned noise signal, which is held in the second memory and corresponds to the same pixel, is held in the second memory, and
the subtraction unit is implemented by one or more processors, circuitry or a combination thereof.

19. An image capturing apparatus comprising:
an image sensor that comprises:
a pixel array in which a plurality of pixels are arranged; and
a first memory configured to hold signals outputted from the pixel array,
each of the plurality of pixels including:
a plurality of photoelectric conversion units that photoelectrically convert light that has passed through different pupil regions of an imaging optical system, and respectively output analog signals;
an analog-to-digital conversion unit that converts the analog signals outputted from the plurality of photoelectric conversion unit into digital signals; and
a latch unit that latches the digital signals converted by the analog-to-digital conversion unit;
an actuation unit that actuates the plurality of pixels;
a second memory, a third memory, and a fourth memory configured to hold digital signals latched by latch unit; and
a subtraction unit;
a dynamic range expansion unit that obtains a pair of focus detection signals having parallax and expanded dynamic range, using the first to fourth signals; and
a focus detection unit that performs phase difference focus detection by using the pair of focus detection signals having parallax and expanded dynamic range,
wherein the first memory holds the digital signals latched by the latch unit,
the actuation unit actuates the plurality of pixels so as to simultaneously output the analog signals to the analog-to-digital conversion unit,
a noise signal, which has been obtained by the analog-to-digital conversion unit converting an analog signal when each of the plurality of pixels is reset into a digital signal and has been latched by the latch unit, is held in the first memory,
a first signal obtained by the subtraction unit subtracting, from a signal, which has been obtained by the analog-to-digital conversion unit converting an analog signal outputted from part of the plurality of photoelectric conversion units of each of the plurality of pixels after the plurality of photoelectric conversion units have been exposed for a predetermined first exposure period into a digital signal and has been latched by the latch unit, the noise signal, which is held in the first memory and corresponds to the same pixel, is held in the second memory,
a second signal obtained by the subtraction unit subtracting, from a signal, which has been obtained by the analog-to-digital conversion unit converting an analog signal outputted from the plurality of photoelectric conversion units of each of the plurality of pixels after the first signal is held in the second memory into a digital signal and has been latched by the latch unit, the noise signal, which is held in the first memory and corresponds to the same pixel, is held in the first memory,
a noise signal, which has been obtained by the analog-to-digital conversion unit converting an analog signal when each of the plurality of pixels is reset after the second signal is held in the first memory into a digital signal and has been latched by the latch unit, is held in the third memory,
a third signal obtained by the subtraction unit subtracting, from a signal, which has been obtained by the analog-to-digital conversion unit converting an analog signal outputted from part of the plurality of photoelectric conversion units of each of the plurality of pixels after the plurality of photoelectric conversion units have been exposed for a predetermined second exposure period, which is different from the first exposure period, into a digital signal and has been latched by the latch unit, the noise signal, which is held in the third memory and corresponds to the same pixel, is held in the fourth memory,
a fourth signal obtained by the subtraction unit subtracting, from a signal, which has been obtained by the analog-to-digital conversion unit converting an analog signal outputted from the plurality of photoelectric conversion units of each of the plurality of pixels after the third signal is held in the fourth memory into a digital signal and has been latched by the latch unit, the noise signal, which is held in the third memory and corresponds to the same pixel, is held in the third memory, and
the subtraction unit is implemented by one or more processors, circuitry or a combination thereof.

20. The image capturing apparatus according to claim 19, wherein
the dynamic range expansion unit further generates one image with expanded dynamic range by using the second signal and the fourth signal.

21. An image capturing apparatus comprising:
an image sensor that comprises:
a pixel array in which a plurality of pixels are arranged; and
a first memory configured to hold signals outputted from the pixel array,
each of the plurality of pixels including:
a plurality of photoelectric conversion units that photoelectrically convert light that has passed through different pupil regions of an imaging optical system, and respectively output analog signals;
an analog-to-digital conversion unit that converts the analog signals outputted from the plurality of photoelectric conversion unit into digital signals; and
a latch unit that latches the digital signals converted by the analog-to-digital conversion unit;
an actuation unit that actuates the plurality of pixels;
an addition unit that adds digital signals, which have been latched by latch unit, in units corresponding to a predetermined number of pixels;
a second memory and a third memory configured to hold added signals obtained by addition by the addition unit; and
a subtraction unit; and
a display unit that displays an image based on the second signal,
wherein the first memory holds the digital signals latched by the latch unit,
the actuation unit actuates the plurality of pixels so as to simultaneously output the analog signals to the analog-to-digital conversion unit,
noise signals, each obtained by the analog-to-digital conversion unit converting an analog signal when each of the plurality of pixels is reset into a digital signal and latched by the latch unit, are added by the addition unit, and an added noise signal is held in the second memory,
a first signal obtained by the subtraction unit subtracting, from a signal obtained by the addition unit adding signals, each obtained by the analog-to-digital conversion unit converting an analog signal outputted from part of the plurality of photoelectric conversion units of each of the plurality of pixels into a digital signal and latched by the latch unit, the added noise signal, which is held in the second memory and corresponds to the same pixel, is held in the third memory,
a second signal obtained by the subtraction unit subtracting, from a signal obtained by the addition unit adding signals, each obtained by the analog-to-digital conversion unit converting an analog signal outputted from the plurality of photoelectric conversion units of each of the plurality of pixels into a digital signal and latched by the latch unit, the added noise signal, which is held in the second memory and corresponds to the same pixel, is held in the second memory, and
the addition unit and the subtraction unit are implemented by one or more processors, circuitry or a combination thereof.

22. An image capturing apparatus comprising:
an image sensor hat comprises:
a pixel array in which a plurality of pixels are arranged; and
a first memory configured to hold signals outputted from the pixel array,
each of the plurality of pixels including:
a plurality of photoelectric conversion units that photoelectrically convert light that has passed through different pupil regions of an imaging optical system, and respectively output analog signals;
an analog-to-digital conversion unit that converts the analog signals outputted from the plurality of photoelectric conversion unit into digital signals; and
a latch unit that latches the digital signals converted by the analog-to-digital conversion unit;
an actuation unit that actuates the plurality of pixels;
a second memory and a third memory configured to hold digital signals thinned out at a predetermined interval among digital signals corresponding to the plurality of pixels; and
a subtraction unit; and
a display unit that displays an image based on the second signal,
wherein the first memory holds the digital signals latched by the latch unit,
the actuation unit actuates the plurality of pixels so as to simultaneously output the analog signals to the analog-to-digital conversion unit,
a thinned noise signal, which has been obtained by thinning out noise signals, each obtained by the analog-to-digital conversion unit converting an analog signal when each of the plurality of pixels is reset into a digital signal and latched by the latch unit, is held in the second memory,
a first signal obtained by the subtraction unit subtracting, from a signal obtained by thinning out signals, each obtained by the analog-to-digital conversion unit converting an analog signal outputted from part of the plurality of photoelectric conversion units of each of the plurality of pixels into a digital signal and latched by the latch unit, the thinned noise signal, which is held in the second memory and corresponds to the same pixel, is held in the third memory,
a second signal obtained by the subtraction unit subtracting, from a signal obtained by thinning signals, each obtained by the analog-to-digital conversion unit converting an analog signal outputted from the plurality of photoelectric conversion units of each of the plurality of pixels into a digital signal and latched by the latch unit, the thinned noise signal, which is held in the second memory and corresponds to the same pixel, is held in the second memory, and
the subtraction unit is implemented by one or more processors, circuitry or a combination thereof.
